(19) United States
(12) Patent Application Publication
(10) Pub. No.: US 2014/0074615 A1
(43) Pub. Date: Mar. 13, 2014

(54) Commerce System and Method of Controlling the Commerce System Using Triggered Advertisements

(71) Applicant: SUPER TRANSCON IP, LLC, Scottsdale, AZ (US)

(72) Inventors: Jason R. Hope, Scottsdale, AZ (US); Matthew E. Harward, Phoenix, AZ (US)

(73) Assignee: Super Transcon IP, LLC, Scottsdale, AZ (US)

(21) Appl. No.: 13/871,986

(22) Filed: Apr. 26, 2013

Related U.S. Application Data
(63) Continuation-in-part of application No. 13/608,243, filed on Sep. 10, 2012.

(51) Int. Cl. G06Q 30/02

(52) U.S. Cl. CPC G06Q 30/0267
USPC 705/14.64

(57) ABSTRACT

A module is provided to monitor an electronic device. An advertisement and a triggering event are delivered to the module. The triggering event is detected based on a status of the electronic device. The advertisement is presented on a graphical interface of the electronic device in response to the triggering event. The advertisement is stored in a database and delivered to the electronic device. The advertisement further includes presenting a notification. The advertisement further includes presenting an overlay. The advertisement further includes a list of triggering events containing the triggering event. The triggering event includes an application download or an application installation. Choices for selecting individual permissions to monitor a component of the computer system are presented. The triggering event includes an application search, an application download, or an application installation. The triggering event further includes a set of running applications.

### CLAIM OF DOMESTIC PRIORITY

The present application is a continuation-in-part of U.S. patent application Ser. No. 13/608,243, filed Sep. 10, 2012, which application is incorporated herein by reference.

### FIELD OF THE INVENTION

The present invention relates in general to consumer purchasing and, more particularly, to a commerce system and a method of controlling the commerce system by using triggered advertisements.

### BACKGROUND OF THE INVENTION

People rely on electronic communication in virtually every phase of business and personal activities, and computers have become a ubiquitous part of modern life. In recent years, mobile electronic devices such as cellular telephones, laptop personal computers, tablet personal computers, and personal digital assistants (PDAs) have enabled consumers and businesses to stay in constant contact. For many people, mobile electronic devices have become essential tools for both personal and professional life.

Over time, the technology of mobile electronic devices has evolved. For example, cellular telephones have transitioned from large devices with limited functionality into modern smartphones, which are sophisticated computer systems small enough to carry in the palm of a hand. Modern smartphones combine the functionality of mobile telephones with the functionality of other electronic devices, such as personal computers, tablets, digital cameras, PDAs, global positioning system (GPS) navigation units, digital music players, and web browsers into a single mobile device.

One of the common features of modern mobile device or smartphone technology is the ability for consumers to download software applications (apps) developed by the product manufacturer, data service providers, or third-party software developers onto mobile devices. Mobile device software applications capitalize on the sophisticated capabilities of the mobile device hardware and operating system to further enhance the functionality of the mobile device. For example, a third-party software application developer can develop a software application that utilizes a mobile device's GPS receiver and web browsing capability to provide the user with directions and navigation to a particular destination. Another third-party software application developer can develop a software application that integrates a mobile device's web browsing and computer processing capability with the functionality of a built-in high-resolution digital camera to enable the user to take a photograph and upload the photograph to a social networking Internet website.

The market for mobile device software applications has become a lucrative business for product manufacturers, service providers, and third-party software developers alike. One traditional model for monetizing mobile device software applications is to charge consumers a fee for purchasing, downloading, and installing software applications onto mobile devices. Charging a fee for downloading and installing a software application is an imperfect model, however, since fees discourage some percentage of consumers from purchasing the software application. When a consumer perceives the price of a software application as too high, or when a consumer is unfamiliar with a software application, the consumer is often reluctant to pay a fee. Consumers also tend to have a low threshold for paying fees to purchase software applications that are unlikely to be used frequently.

In order to encourage consumers to install and use software applications, software developers commonly offer versions of software applications free of charge. The free version may be a trial version, with limited functionality or limited use, allowing consumers to experiment with the software application before deciding whether to purchase the full version of the product. Some software developers have also implemented an advertisement-based revenue-generating model to enable providing full versions of software to consumers free-of-charge. The advertisement-based revenue-generating model for software applications involves embedding advertisements within a software application. Embedded advertisements may simply display promotional text for a product or service. More commonly, embedded advertisements display promotional text coupled with a hyperlink to redirect the consumer to a sales website for a product or service. The software developer then collects a fee from the advertiser or an advertiser network each time an advertisement is displayed. Alternatively, the software developer collects a fee from the advertiser or advertiser network every time a user clicks on an advertisement. Thus, embedded advertisements enable software developers to shift the direct cost of installing a software application away from the consumer using the software applications. Embedded advertisements provide a convenient mechanism for software developers to monetize software applications without discouraging consumers from using the software applications.

Unfortunately, the conventional embedded advertisement model of generating revenue has limited potential for controlling or influencing the purchasing decisions of consumers. Due to the broad variety of tastes and interests among consumers, it is unlikely that any particular consumer exposed to a conventional embedded advertisement will be interested in purchasing the advertised product or service. Therefore, the conventional embedded advertisement model relies on exposing a high volume of consumers to a high volume of advertisements. Exposing a large number of consumers to numerous advertisements increases the likelihood that some consumers ultimately purchase the advertised product or service. The percentage of consumers who decide to click on an embedded advertisement is typically very low. The percentage of consumers who convert into purchasers of the product or service is even lower. Thus, the conventional embedded-advertisement model for generating revenue is inefficient. Consumers are exposed to unappealing or irrelevant advertisements at the expense of not being exposed to advertisements for products or services that are more appealing. Advertisers waste money and advertisement opportunities by paying for unappealing advertisements. Software developers miss increased revenue opportunities by displaying unappealing advertisements at the expense of not displaying advertisements that are more appealing.

### SUMMARY OF THE INVENTION

A need exists to deliver contextual targeted advertisements to users of mobile devices in order to optimize and maximize the influence of advertisements on commercial transactions within the commerce system. Accordingly, in one embodiment, the present invention is a method of controlling a commerce system comprising the steps of providing a module to monitor an electronic device, delivering an advertisement and a triggering event to the module, detecting the triggering event based on a status of the electronic device, and presenting the advertisement on a graphical interface of the electronic device in response to the triggering event.

In another embodiment, the present invention is a method of controlling a commerce system comprising the steps of delivering an advertisement to an electronic device, monitoring an electronic device for a triggering event, and presenting the advertisement on a graphical interface of the electronic device in response to the triggering event.

In another embodiment, the present invention is a method of controlling a commerce system comprising the steps of monitoring a status of a computer system to detect a triggering event, and presenting an advertisement over an interface of the computer system in response to the triggering event.

In another embodiment, the present invention is a computer program product usable with a programmable computer processor including a computer readable program code embodied in a non-transitory computer usable medium for controlling a commerce system comprising the steps of delivering an advertisement to an electronic device, monitoring an electronic device for a triggering event, and presenting the advertisement on a graphical interface of the electronic device in response to the triggering event.

### BRIEF DESCRIPTION OF THE DRAWINGS

FIG. 1 illustrates a commerce system comprising consumers and businesses engaging in electronic communication through a network;

FIG. 2 illustrates businesses engaging in commercial transactions within a commerce system;

FIG. 3 illustrates a commercial supply, distribution, and consumption chain controlled by a demand model;

FIG. 4 illustrates an electronic communication network between members of the commerce system;

FIG. 5 illustrates a computer system operating with the electronic communication network;

FIGS. 6a-6c illustrate a mobile device computer system;

FIG. 7 illustrates a consumer profile registration graphical interface with an application provider;

FIG. 8 illustrates a consumer login graphical interface for an application provider;

FIG. 9 illustrates an application store graphical interface;

FIGS. 10a-10b illustrate a user browsing applications using an application store graphical interface;

FIG. 11 illustrates components of a software application;

FIGS. 12a-12b illustrate a permission-setting process during installation of a software application on a mobile device;

FIG. 13 illustrates a user engaging with a software application installed on a mobile device;

FIG. 14 illustrates an advertisement stored on an advertisement database;

FIG. 15 illustrates the structure of an advertisement database;

FIG. 16 illustrates a cross-referencing computer system comparing permissions provided by a user with permission lists of advertisements stored in an advertisement database;

FIG. 17 illustrates a determination by a cross-referencing computer system;

FIG. 18 illustrates a software application after embedding advertisements on a mobile device;

FIG. 19 illustrates a user engaging with a software application on a mobile device and receiving a notification;

FIG. 20 illustrates a user returning to a software application store graphical interface to browse software applications;

FIG. 21 illustrates the structure of a software application;

FIGS. 22a-22b illustrate a user selecting permissions while installing a software application on a mobile device;

FIG. 23 illustrates a cross-referencing computer system determining advertisements that are compatible with a software application;

FIG. 24 illustrates a software application after delivering advertisements to a mobile device;

FIG. 25 illustrates a software application displaying an advertisement notification in response to a triggering event;

FIG. 26 illustrates a user engaging with a software application prior to a triggering event;

FIG. 27 illustrates displaying an advertisement notification in response to a triggering event;

FIG. 28 illustrates displaying an alternative advertisement notification to a user in response to a triggering event;

FIG. 29 illustrates a user browsing software applications using a software application store graphical interface;

FIG. 30 illustrates a representative software application;

FIGS. 31a-31b illustrate a user installing a software application on a mobile device;

FIG. 32 illustrates a cross-referencing computer system determining advertisements that are compatible with required and optional permissions;

FIG. 33 illustrates a software application with advertisements embedded in an advertising module;

FIG. 34 illustrates a user interacting with a graphical interface of a mobile device;

FIG. 35 illustrates a user managing applications running on a mobile device;

FIG. 36 illustrates an advertisement notification layered over a graphical interface on a mobile device;

FIG. 37 illustrates a process of controlling activities in a commerce system by layering advertisement notifications over a graphical interface of a computer system

FIGS. 38a-38b illustrate a search for a software application triggering a notification advertisement;

FIGS. 39a-39b illustrate the download or installation of an application triggering an overlay advertisement;

FIGS. 40a-40b illustrate launching an application and triggering an advertisement;

FIG. 41 Illustrates a banner advertisement triggered by detecting a set of running applications;

FIG. 42 illustrates a banner advertisement triggered by detecting a set of running or installed applications;

FIGS. 43a-43b illustrate presentation of a triggered advertisement to a user through an augmented reality device; and

FIG. 44 illustrates a process of controlling a commerce system by presenting advertisements in response to triggering events.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

In recent years, mobile computer systems and mobile devices have become important tools for maintaining contact with friends, colleagues, and clients. People also rely on mobile devices for performing activities of daily living such as purchasing goods and services. Similarly, in order to remain competitive in the marketplace, businesses rely on sophisticated mobile devices to manage and operate the day-to-day functions of engaging in commercial activity.

Consumer demand for more sophisticated mobile devices has encouraged mobile device manufacturers to strive for constant improvement of mobile device hardware and software. Mobile devices are smaller and faster today than ever before. In fact, modern electronic devices are often small enough to carry in the palm of a hand, but sophisticated enough to perform functions previously performed by several different computer systems. For example, the modern smartphone merges the functionality of the cellular telephone with the functionality of personal computers, music players, digital cameras, and other devices into a single mobile device. Consumers use smartphones to engage in telephone conversations with friends and colleagues, browse the Internet, play video games, send and receive email and text messages, shop for goods and services, locate and find information on local retail establishments, pay bills, purchase and listen to music, read books and magazines, receive news alerts, watch television, navigate cities, and perform other activities of day-to-day life. In short, mobile electronic devices have assumed a critical role in the modern commerce system.

Along with the technological advancements of mobile device hardware, a market has emerged for developing software applications to enable consumers to take full advantage of the sophisticated hardware within mobile devices. The market is facilitated by the common availability of mobile device software development kits (SDKs). Mobile device SDKs enable third-party software developers to create software applications that are compatible with the mobile device. The software applications can typically be downloaded to memory within the mobile device and smoothly integrated with the mobile device's operating system and hardware to enhance the functionality of the mobile device and generally improve the consumer experience. Consumer demand for software applications that enable consumers to fully exploit the capabilities of mobile devices has given rise to a lucrative business for software developers. Consumers are eager to download software applications that make life easier, more efficient, and more entertaining.

At the same time, consumers are often reluctant to pay for software applications that come from unreliable or unknown software developers without a track record of providing quality products. Furthermore, low barriers to entry into the software application market for mobile devices combined with high consumer demand for new software applications has led to steep competition among software application developers. Thus, consumers are often unwilling to pay for a particular software application because there are typically alternative software applications available that provide similar functionality for a lower price. Additionally, consumers are often unwilling to pay for a certain software application that the consumers do not expect to use frequently enough to justify the cost.

In order to overcome consumer reluctance to purchase software applications, software developers have turned to alternative business models for generating revenue while simultaneously minimizing direct costs to consumers. For example, a software developer can allow consumers to download a software application free of charge, but enable embedded advertisements within the software application as an alternative revenue source. When consumers are in the process of using the software application, the software application displays an advertisement with an embedded hyperlink redirecting the consumer to an Internet website where the consumer can purchase a product or service. Consumers can click or tap on the advertisement to open a separate Internet browser window to visit the Internet website. If the consumer purchases the product or service, the software developer receives a commission on the sale. Alternatively, the software developer can charge the advertiser a fee for showing an advertisement, or for every time a consumer clicks on a particular advertisement.

The embedded-advertisement model enables software developers to generate revenue without charging a fee for downloading a software application, since fees tend to discourage some consumers from using the software application. Thus, consumers benefit from the embedded-advertisement model of generating revenue because consumers can use software applications free of charge in exchange for agreeing to be exposed to advertisements. Advertisers also benefit from the embedded-advertisement model by having a platform for marketing products and services to consumers.

In the face of increasing competition in the market for software applications, coupled with mounting expectations from consumers, software developers need to continually strive to provide quality products at lower cost to consumers while simultaneously generating enough revenue to remain profitable. Unfortunately, the embedded advertisement model has limitations that reduce revenue potential for software developers and advertisers. For example, conventional software applications with embedded advertisements require active engagement by consumers with the software application in order to generate revenue, since consumers are only exposed to advertisements while actively using the software application. Thus, software applications that are only used occasionally tend to be less profitable than applications that are used regularly. Furthermore, the opportunity to display advertisements is limited to the narrow window of time that a consumer is actively engaging with the software application. Displaying an advertisement for a product or service that is unappealing to a consumer is a wasted opportunity to show a more appealing advertisement.

Additionally, conventional embedded advertisements are removed from much of the context of consumer behavior or activity at the time the consumer is exposed to the advertisement. For example, a software developer may embed a conventional advertisement in a video game software application with promotional text for a particular soft drink and a hyperlink to a sales website to purchase the soft drink. Due to varying tastes, any individual consumer playing the video game and exposed to the advertisement may not enjoy the particular advertised soft drink. Furthermore, because consumers playing the video game are engaged in playing the video game when the advertisement is displayed, there is a low likelihood that any individual consumer will stop playing the video game, click on the advertisement, and purchase the soft drink.

Conventional embedded advertisements do not take into account the context of consumers' activities and the likelihood that any particular advertisement will be relevant or appealing to a consumer at the particular moment the advertisement is displayed. If an advertisement embedded in a software application has a hyperlink to redirect a consumer to a product sales website, the likelihood that any particular consumer exposed to the advertisement will choose to visit the product sales website is low. The likelihood that a consumer exposed to an advertisement will convert into a consumer who chooses to purchase a product or service after visiting a product sales website is even lower. Thus, advertisers typically rely on exposing advertisements to a high volume of consumers in the hopes that some percentage of the consumers will ultimately purchase the advertised product or service.

The low conversion rate from consumers exposed to advertisements into consumers who purchase products or services is inefficient. Consumers may feel bombarded or overwhelmed by advertisements for products and services that are irrelevant or unappealing. Some consumers may begin to ignore advertisements altogether. Thus, consumers lose the opportunity to be exposed to advertisements for products and services that are most likely to appeal to consumers' individual interests and tastes. At the same time, software developers waste valuable advertising opportunities by displaying advertisements that have a low probability of resulting in a sale. Similarly, advertisers waste money paying to display advertisements to consumers who are unlikely to purchase the advertisers' products or services. To reduce inefficiencies in the commerce system, advertisers and software developers must maximize the effectiveness of advertising campaigns by delivering advertisements to consumers in the context of the consumers' mindset or interests at the time of exposure to the advertisement.

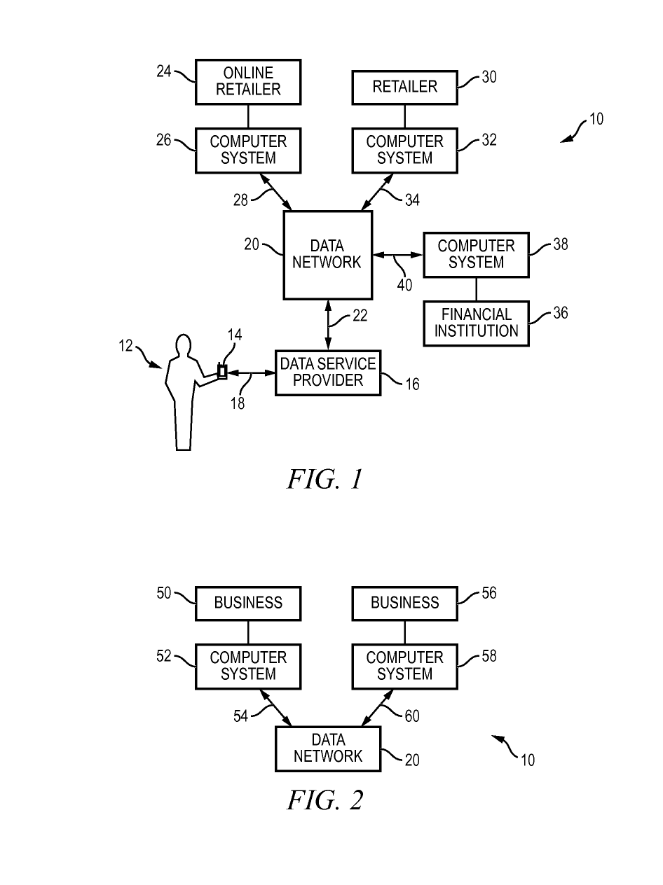

FIG. 1 shows a commerce system 10 comprising consumers and businesses engaging in electronic communication through a data network to purchase and sell products and services. The terms, products and services are interchangeable in the commerce system. Consumer 12 has a computer system or mobile device 14. Consumer 12 is an individual or entity capable of purchasing goods and services for personal or business purposes. Computer system or mobile device 14 can be any computer such as a desktop or laptop personal computer, or a mobile device such as a cellular telephone, smartphone, PDA, or other similar device capable of sophisticated data processing and electronic communication with other devices. Mobile device 14 is in electronic communication with data service provider 16 by way of communication channel or link 18. Communication channel 18 is bi-directional and transmits data between consumer 12 and data service provider 16 in a hard-wired or wireless configuration. Data service provider 16 can be a mobile network operator providing data and voice service through a series of cellular telephone towers, computer networks, and orbiting satellites to provide telephone and data service to consumer 12 through mobile device 14. Alternatively, data service provider 16 can be a broadband or telecommunications service provider. Data service provider 16 is in electronic communication with data network 20 by way of communication channel or link 22. Communication channel 22 is bi-directional and transmits data between data service provider 16 and data network 20 in a hard-wired or wireless configuration. Data network 20 is a distributed network of interconnected routers, gateways, switches, and servers, each with a unique Internet Protocol (IP) address to enable communication between individual computers, cellular telephones, electronic devices, or nodes within the network. In one embodiment, data network 20 is a global, open-architecture network, commonly known as the Internet.

Commerce system 10 further includes online retailer 24 operating computer system 26 in electronic communication with data network 20 over communication channel or link 28. Communication channel 28 is bi-directional and transmits data controlled by online retailer 24 between computer system 26 and data network 20. Online retailer 24 offers goods and services through one or more Internet websites operated by online retailer 24 using computer system 26. For example, online retailer 24 can sell books, movies, consumer electronics, jewelry, clothing, toiletries, beauty products, appliances, and other tangible consumer products. Online retailer 24 also provides downloadable digital media such as digital movies, television shows, or music that can be streamed to consumers from computer system 26 through data network 20. Online retailer 24 can also manage and maintain one or more Internet weblogs (blogs), which provide advice or information on various topics and display advertisement banners for products and services of third-party retailers. Using mobile device 14, consumer 12 can purchase goods and services from online retailer 24 by browsing Internet websites stored on one or more computer systems or servers in electronic communication with data network 20 and managed by online retailer 24.

Commerce system 10 further includes retailer 30 operating computer system 32 in electronic communication with data network 20 over communication channel or link 34. Communication channel 34 is bi-directional and transmits data between retailer 30 and data network 20 using computer system 32. Retailer 30 can be a food store chain, general consumer product retailer, drug store, discount warehouse, department store, apparel store, specialty store, or service provider. Using mobile device 14, consumer 12 can search for reviews and information about the products and services of retailer 30 through third-party Internet websites or Internet websites operated and maintained by retailer 30 through data network 20.

Commerce system 10 further includes financial institution 36 operating computer system 38 in electronic communication with data network 20 over communication channel or link 40. Communication channel 40 is bi-directional and transmits data between financial institution 40 and data network 20 using computer system 38. Financial institution 36 is a bank, credit union, credit card network or other financial services company that facilitates financial transactions within commerce system 10. Using mobile device 14, consumer 12 has a checking or savings account or a line of credit with financial institution 36. Consumer 12 can review account balances, transfer funds, pay bills, or make other financial transactions with financial institution 36. Alternatively, consumer 12 purchases goods or services from online retailer 24 or retailer 30 and provides authorization to financial institution 36 to electronically transfer funds from the bank account or credit line of consumer 12 through data network 20 to online retailer 24 or retailer 30.

FIG. 2 illustrates businesses engaging in commercial transactions within commerce system 10. Commerce system 10 includes business 50 operating with computer system 52 in electronic communication with data network 20 over communication channel or link 54. Similarly, commerce system 10 includes business 56 operating with computer system 58 in electronic communication with data network 20 over communication channel or link 60. Communication channels 54 and 60 are bi-directional and transmit data between businesses 50 and 56 and data network 20 using computer systems 52 and 58, respectively.

Business 50 provides goods and services to other businesses or to consumers. Business 50 can be a general retail establishment, such as a food store chain, consumer product retailer, office supply store, pharmacy, department store, hardware store, restaurant, or other retail outlet. Business 50 can also be a service provider such as a law firm, consulting agency, accounting firm, architecture firm, information technology (IT) support company, or other service provider. In order to perform the day-to-day functions of running a business or engaging in commercial transactions, business 50 requires inventory or raw materials or other goods and services, which business 50 purchases from business 56 through data network 20. For example, employees of business 50 interface with an Internet website operated and maintained by business 56 and in electronic communication with data network 20 to browse and purchase inventory or raw materials from business 56, or electronically transfer money to business 56. Employees of business 50 and 56 exchange communications to confirm or negotiate transactions via electronic mail (email) using an email server and client in electronic communication with data network 20.

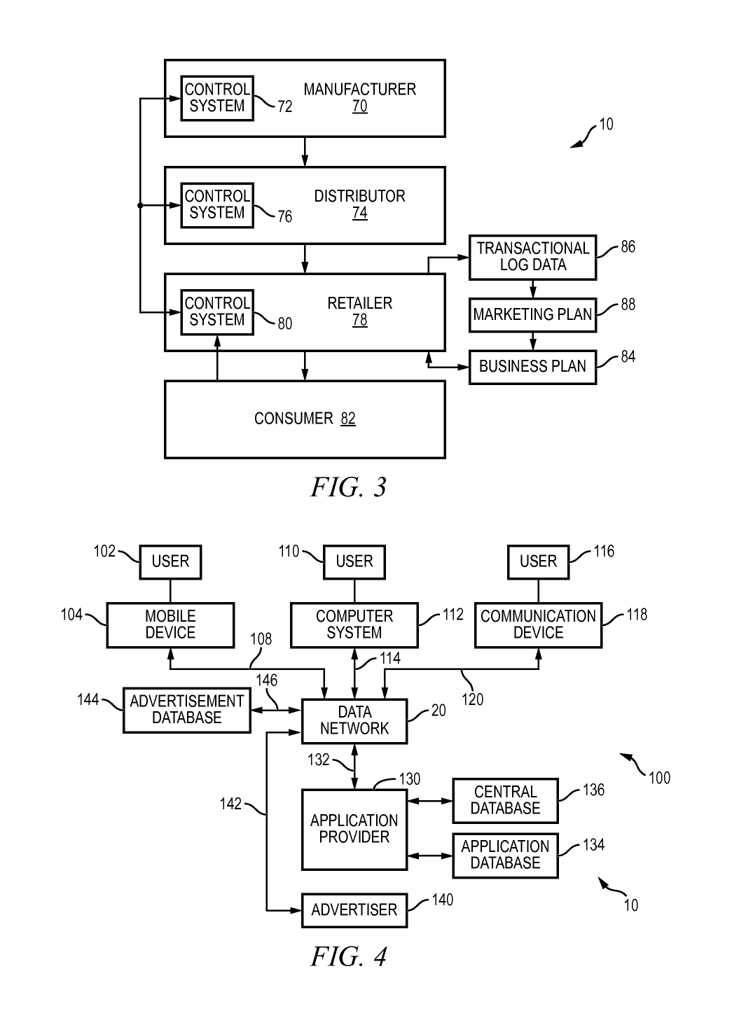

FIG. 3 further illustrates the movement of goods between members of commerce system 10. Manufacturer 70 uses control system 72 to receive orders, control manufacturing and inventory, and schedule deliveries. Distributor 74 receives goods from manufacturer 70 for distribution within commerce system 10. Distributor 74 uses control system 76 to receive orders, control inventory, and schedule deliveries. Retailer 78 receives goods from distributor 74 for sale within commerce system 10. Retailer 78 uses control system 80 to place orders, control inventory, and schedule deliveries with distributor 74. Retailer 78 has certain product lines or services available to consumer 82 as part of its business plan 84. Retailer 78 can be a food store chain, general consumer product retailer, drug store, discount warehouse, department store, apparel store, specialty store, or service provider. Alternatively, retailer 78 can be an online retailer that offers products and services to consumer 82 through an Internet website. Retailer 78 has the ability to set pricing, order inventory, run promotions, arrange its product displays, collect and maintain historical sales data, and adjust its strategic business plan 84. Business plan 84 gives retailer 78 the ability to evaluate performance and trends, make strategic decisions, set pricing, order inventory, hire employees, expand stores, add and remove product lines, organize product shelving and displays, select signage, design and maintain an Internet website, and the like. Business plan 84 allows retailer 78 to analyze data, evaluate alternatives, and make decisions to control its operations.

Retailer 78 routinely enters into sales transactions with consumer 82. In fact, retailer 78 maintains and updates its business plan to increase the number of transactions (and thus revenue and/or profit) between retailer 78 and consumer 82. Consumer 82 can be a specific individual, account, or business entity. For each sale transaction entered into between retailer 78 and consumer 82, information describing the transaction is stored as transactional log data 86. When a consumer goes through the checkout process at a physical retail store outlet or an online retail store, data is collected about the product or service and stored by a point-of-sale (POS) system, or other suitable data storage system, as transactional log data 86. Transactional log data 86 includes the current price, any related promotions, any relevant merchandizing information associated with the product, the number of units purchased, and the total revenue generated by the sale. The date and time, store, and consumer information corresponding to the purchase are also recorded.

Retailer 78 also prepares and executes on marketing plan 88 to evaluate consumer behavior and patterns and run promotions directed toward those behaviors in order to increase sales. Transactional log data 86 can be used to revise marketing plan 88. Marketing plan 88 in turn influences business plan 84. Retailer 78 can change business plan 84 and marketing plan 88 as needed.

Consumer 82 patronizes retailer 78, either in person or using an online retail interface. Marketing plan 88 utilized by retailer 78 influences the purchasing decisions made by consumer 82. A more effective marketing plan 88 increases the sale of goods and services, which drives manufacturing, distribution, and retail portions of commerce system 10. More purchasing decisions made by consumer 82 for retailer 78 lead to more merchandise movement for all members of commerce system 10. Manufacturer 70, distributor 74, and retailer 78 respond to the sales volume by controlling and optimizing the ordering, manufacturing, distribution, and sale of goods, and otherwise execute a business plan within commerce system 10 in accordance with the purchasing decisions made by consumer 82.

FIG. 4 shows an electronic communication network 100 within commerce system 10 for transmitting information between computer systems operated by users and an application provider. The terms computer system, mobile device, and communication device are interchangeable in the commerce system. The terms consumer and user are interchangeable in the communication network within the commerce system. User 102 operating with mobile device 104 is connected to data network 20 by way of communication channel or link 108. Likewise, user 110 operating with computer system 112 is connected to data network 20 by way of communication channel or link 114, and user 116 operating with communication device 118 is connected to data network 20 by way of communication channel or link 120. Communication channels 108, 114, and 120 are bi-directional and transmit data between data network 20 and mobile device 104, computer system 112, and communication device 118, respectively, in a hard-wired or wireless configuration. For example, mobile device 104, computer system 112, and communication device 118 have email, texting, and Internet capability.

Electronic communication network 100 further includes application provider 130 in electronic communication with data network 20 over communication channel or link 132. Communication channel 132 is bi-directional and transmits data between application provider 130 and data network 20 in a hard-wired or wireless configuration. Application provider 130 provides software applications, which can be downloaded through data network 20 and installed onto mobile device 104, computer system 112, and communication device 116 in response to requests from users 102, 110, and 116. Application provider 130 can be a computer system or mobile device manufacturer, or a data service provider. Application provider 130 can also be a third-party software developer. Application provider 130 maintains an online software application store or application database 134 to compile and index software applications compatible with particular computer systems or mobile devices. Application provider 130 also maintains a central database 136 including one or more servers for storing and cataloging user information.

Electronic communication network 100 further includes advertiser 140 in electronic communication with data network 20 over communication channel or link 142. Communication channel 142 is bi-directional and transmits data between advertiser 140 and data network 20 in a hard-wired or wireless configuration. In one embodiment, advertiser 140 and application provider are the same business organization or entity. Advertiser 140 is a retailer or marketing company who creates advertisements for particular products to be embedded within software applications available through application provider 130. In one embodiment, advertiser 140 is an advertising network that compiles, sorts, and maintains advertisements on behalf of retailers and marketing companies to be embedded within software applications available through application provider 130.

Electronic communication network 100 further includes an advertisement database 144 in electronic communication with data network 20 over communication channel or link 146. Communication channel 146 is bi-directional and transmits data between data network 20 and advertisement database 144 in a hard-wired or wireless configuration. Alternatively, advertisement database 144 is not directly connected to data network 20, but instead is in direct electronic communication with a particular entity capable of transmitting information from advertisement database 144 to data network 20, such as application provider 130 or advertiser 140. Advertisement database 144 can be managed and maintained by advertiser 140, application provider 130, or a third party. Advertisement database 144 stores and indexes advertisements from advertiser 140, along with relevant data for the advertisements. Application provider 130 or advertiser 140 can upload advertisements to advertisement database 144 through data network 20.

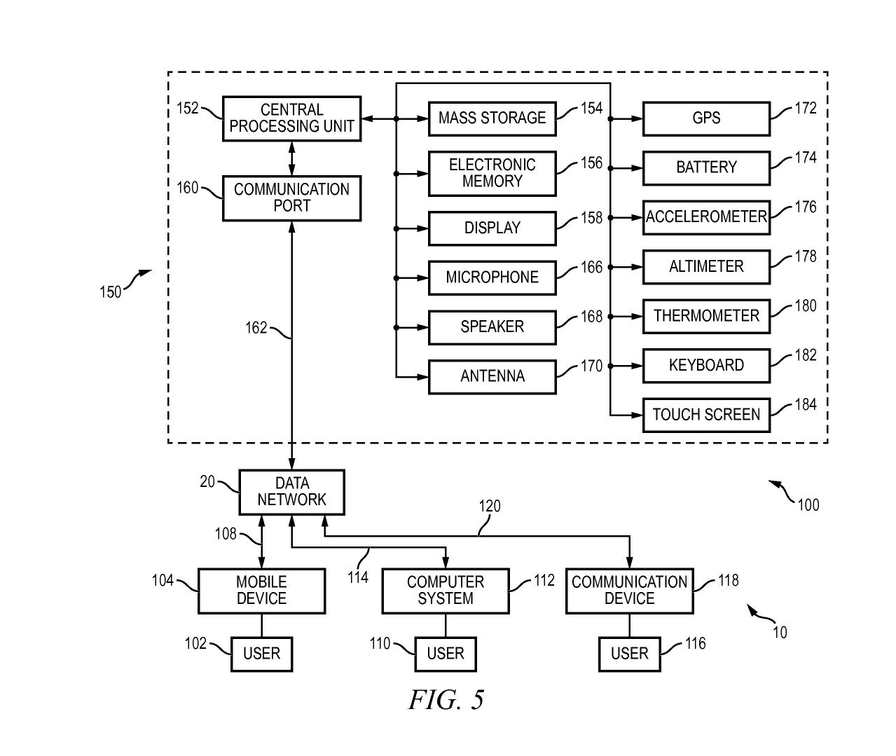

Further detail of computer systems used in electronic communication network 100 is shown in FIG. 5 as a computer system 150 for executing a software program used in the electronic communication process. Computer system 150 is a general-purpose computer or mobile device and includes a central processing unit or microprocessor 152, mass storage device or hard disk 154, electronic memory 156, display 158, and communication port 160. Communication port 160 represents a modem, high-speed Ethernet link, wireless, or other electronic connection to transmit and receive input/output (I/O) data over communication link 162 to data network 20.

Several other components controlled by central processing unit 152 are included in computer system 150. For example, in embodiments where computer system 150 is a mobile device or cellular telephone with advanced computing and connectivity (i.e., a smartphone), computer system 150 includes a microphone 166, speaker 168, and antenna 170 to receive, amplify, and exchange data signals including voice signals. Computer system 150 includes GPS receiver 172 that tracks the location of computer system 150 by transmitting to and receiving electronic signals from orbiting satellites to calculate the position of computer system 150. Computer system 150 includes a battery 174 to provide electrical power to computer system 150 without the need to be electrically connected to an external power source. Computer system 150 includes an accelerometer 176 capable of sensing and measuring the movement and acceleration of computer system 150. Computer system 150 includes an altimeter 178 for measuring and calculating the altitude of computer system 150. Computer system 150 includes one or more thermometers 180, capable of measuring the internal and external temperature of computer system 150. Computer system 150 also includes keyboard 182 for enabling a user to enter commands or otherwise interact with computer system 150 by inputting text. Alternatively, computer system 150 includes a touchscreen 184 capable of sensing physical touch from a user. Computer system 150 includes other buttons or hardware components enabling users to interact with computer system 150 and capable of measuring and monitoring the state of computer system 150. Each of the components in computer system 150 is interfaced with one or more central processing units 152 capable of executing software applications stored on mass storage device 154 or electronic memory 156 and coordinating the functionality of each of the components. Mobile device 104, computer system 112, and communication device 118 can be configured to have some or all of the components as shown for computer 150.

Computer systems 150 and 112 and communication device 118 can be physically located in any location with access to a modem or communication link to data network 20. For example, computer systems 150 or 112 or communication device 118 can be located in a user's home or business office. Alternatively, computer systems 150 or 112 or communication device 118 can be mobile and follow the user to any convenient location, e.g., remote offices, customer locations, hotel rooms, residences, vehicles, public places, or other locales with electronic access to data network 20. Computer systems 150 and 112 are a desktop or laptop computer. Application provider 130 may use computer system 150 or 112 in its business office. Mobile device 104 is a mobile communication device such as a cellular telephone with advanced computing and connectivity capability (i.e., a smartphone), tablet personal computer, PDA, digital glasses, digital contact lenses, digital watches, or other similar electronic device designed for mobile communication, information presentation, or data processing. Communication device 118 is a personal computer or other electronic device with advanced computing capability such as a video game console or portable or handheld gaming console.

Each of computer systems 150 and 112, mobile device 104, and communication device 118 runs application software and computer programs, which can be used to display graphical user interface screens, execute the functionality, and provide the electronic communication features as described below. The application software includes an Internet browser, local email application, word processor, spreadsheet, and the like. In one embodiment, the screens and functionality come from the application software, i.e., the electronic communication runs directly on computer systems 150 and 112, mobile device 104, or communication device 118. Alternatively, the screens and functions are provided remotely from one or more websites stored on computer systems or servers in electronic communication with data network 20.

The application software is originally provided on computer readable media, such as compact disks (CDs), external drive, flash memory cards, or other mass storage medium. Alternatively, the application software is downloaded from electronic links, such as a host, vendor, or software developer's website and stored on a tangible or non-transitory mass storage medium. Alternatively, the application software is downloaded through an online application store or database containing a compilation of software applications compatible with the computer system. The software is installed onto mass storage device 154 and/or electronic memory 156, and is accessed and controlled by the computer operating system. Software updates are also electronically available on mass storage medium or downloadable from the host or vendor website. The software, as provided on the computer readable media or downloaded from electronic links, represents a computer program product containing computer readable program code embodied in a non-transitory or tangible computer readable or computer usable medium.

The electronic communication network 100 can be used for a variety of business, commercial, personal, educational, and government purposes or functions. For example, a consumer using mobile device 104 can communicate with application provider 130 operating on computer 150. The electronic communication network 100 is an integral part of a business, commercial, professional, educational, government, or social network involving the interaction of people, processes, and commerce within commerce system 10.

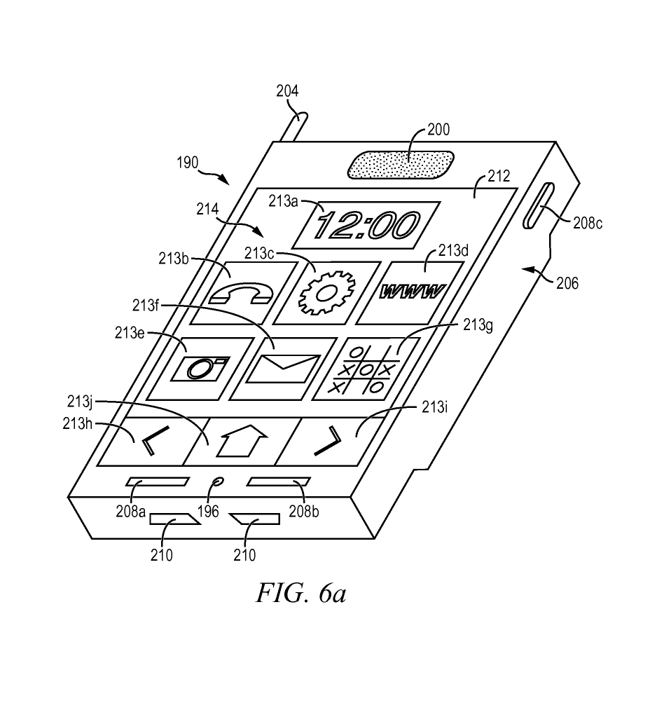

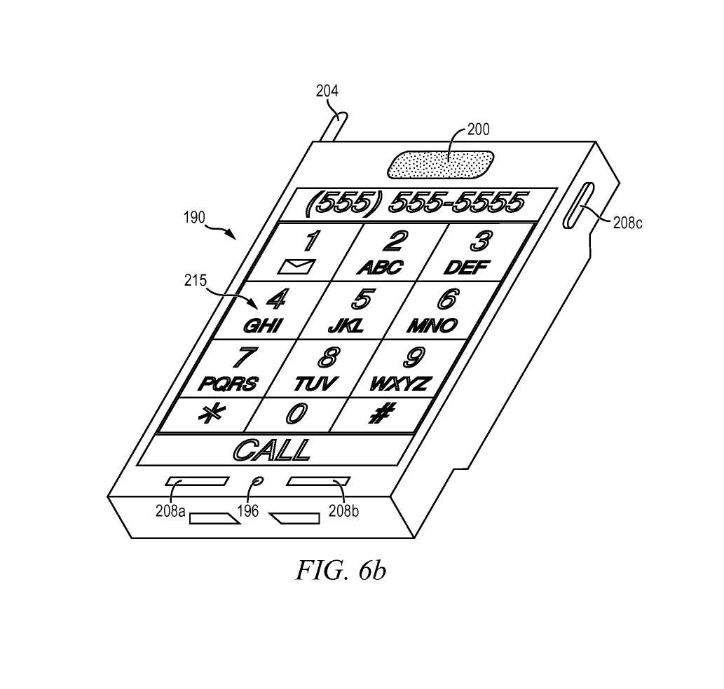

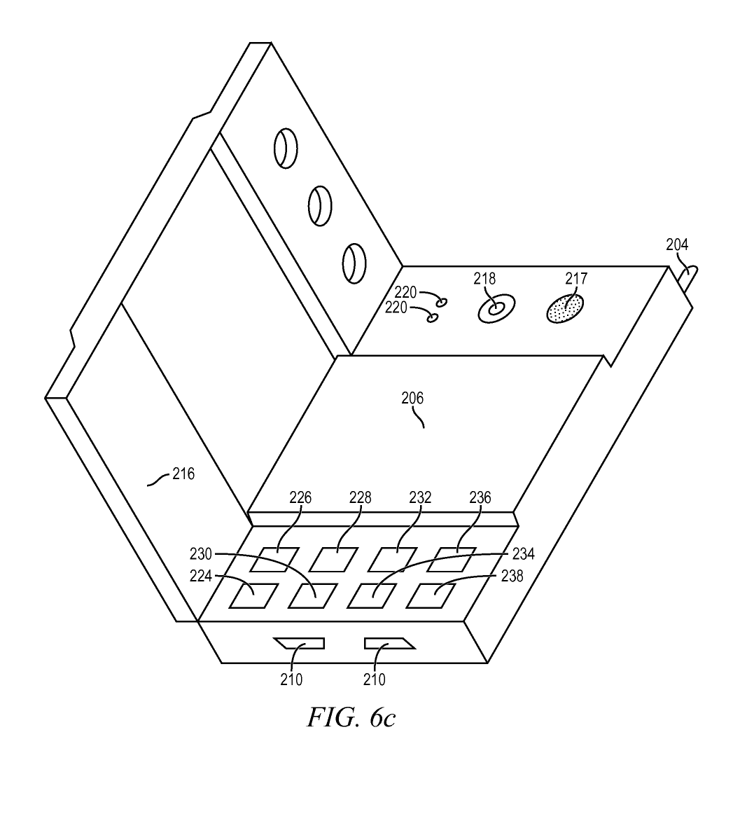

FIG. 6a shows an exemplary computer system or mobile device 190, configured similar to computer system 150. Mobile device 190 runs a sophisticated mobile device operating system platform capable of incorporating and controlling the features of a mobile device. Mobile device 190 includes a microphone 196, speaker 200, and antenna 204 to receive, amplify, and exchange data signals including voice signals. Mobile device 190 also has a battery 206 to provide electrical power to mobile device 190 without the need for mobile device 190 to be electrically connected to an external power source at all times. Mobile device 190 has a plurality of buttons, including buttons 208a-208c for interacting with and providing commands to mobile device 190. A user can input data into or interact with mobile device 190 using buttons 208a-208c. Mobile device 190 also has a plurality of communication or data ports 210 for providing electrical connection to transmit and receive I/O data. Data ports 210 can be configured to receive data cables with a wired interface such as high-speed Ethernet, Universal Serial Bus (USB), High-Definition Multimedia Interface (HDMI), tip-ring-sleeve (TRS) connector, or other similar analog or digital data interface. Alternatively, data ports 210 can be configured to transmit and receive I/O data wirelessly. Mobile device 190 also has a display or touchscreen 212 capable of sensing physical touch from a user to enable a user to interact with and provide commands to mobile device 190. In another embodiment, mobile device 190 has a screen or display that is not capable of sensing physical touch and a keyboard or keypad interface to enable a user to interact with and provide commands to mobile device 190. Touchscreen 212 is also capable of displaying static or dynamic images, text, and colors.

Mobile device 190 is capable of displaying icons and digital buttons on touchscreen 212 in the form of a plurality of icons 213a-213j, which enables a user to selectively interact and engage with mobile device 190. For example, mobile device 190 has a digital clock software application installed on the device and user can read the time displayed within icon 213a on touchscreen 212, or change the time, set an alarm, or start a timer by tapping clock icon 213a to bring up a separate screen or digital display on touchscreen 212. A user can make a telephone call by touching phone icon 213b to bring up a telephone graphical interface screen 215, as shown in FIG. 6b. Returning to FIG. 6a, a user can choose to review and change settings of mobile device 190 by touching settings icon 213c, or browse the Internet by touching browser icon 213d. A user can choose to capture or review photos by touching camera icon 213e. A user can send or receive voice, email, or Short Message Service (SMS) text messages by touching message icon 213f. A user can browse, play, or purchase games by touching game icon 213g. Several other software applications or functionalities are installed on mobile device 190 and a user can navigate through the various choices by touching navigation icons 213h or 213i. A user can also return to a home screen by touching home icon 213j. Graphical interface home screen 214 displays each of the icons 213a-213j, for interacting with the operating system and software applications of mobile device 190.

In FIG. 6c, mobile device 190 is inverted to show the side of mobile device 190 opposite touchscreen 212. Back cover 216 is removed to expose a portion of the internal components of mobile device 190. Mobile device 190 has a speaker 217 for providing audio output from mobile device 190. Mobile device 190 has a high-resolution digital camera 218 capable of capturing digital images or photographs, or recording digital video. Mobile device 190 has one or more light sources 220, which can be any suitable electronic device capable of emitting light such as a light-emitting diode (LED). Light source 220 can operate as a flash for digital camera 218. Mobile device 190 also has one or more central processing units 224, mass storage device or flash memory 226, and electronic memory 228. Mobile device 190 also has GPS receiver 230 for tracking the location of mobile device 190. Mobile device 190 includes an accelerometer 232 capable of sensing and measuring movement of mobile device 190. Mobile device 190 also includes an altimeter 234, capable of measuring and calculating the altitude of mobile device 190. Mobile device 190 also includes one or more thermometers 236 capable of measuring the internal and external temperature of mobile device 190 and the surrounding environment. Mobile device 190 includes one or more additional components 238 for measuring and monitoring the state or status of mobile device 190.

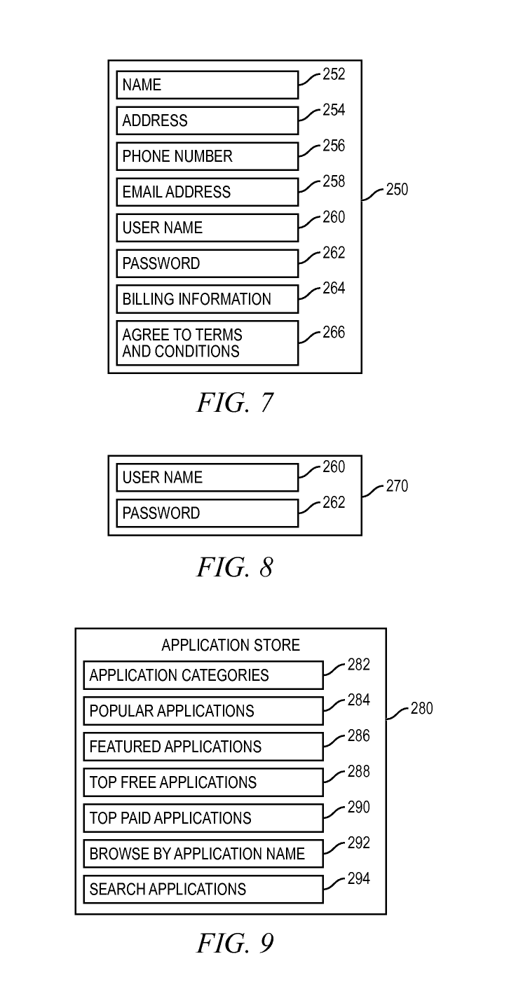

To interact with application provider 130, shown in FIG. 4, users 102, 110, and 116 first create an account and profile with application provider 130. The user accesses application provider graphical interface or website 250 operated by application provider 130 and controlled by computer system 150 and provides data to complete the registration and activation process to create the account and profile, as shown in FIG. 7. Application provider graphical interface 250 can be a website stored on a computer system or server similar to computer system 150 and connected to data network 20. Alternatively, application provider graphical interface 250 can be a software application installed on the user's computer system and capable of accessing one or more computer systems or servers in electronic communication with data network 20 and operated by application provider 130. Users 102, 110, or 116 can access application provider graphical interface 250 using mobile device 104, computer system 112, or communication device 118 by typing the uniform resource locator (URL) for application provider graphical interface 110 into a web browser. Alternatively, users 102, 110, or 116 can access application provider graphical interface 250 using mobile device 104, computer system 112, or communication device 118 by clicking on a banner or hyperlink located on another website, which re-directs the user to a predetermined landing page for application provider graphical interface 110. Alternatively, in an embodiment where application provider graphical interface is a software application already installed on the user's computer system, the user can run the application on the computer system.

The data provided by users 102, 110, or 116 to application provider 130 through application provider graphical interface 250 includes name in block 252, address with zip code in block 254, phone number in block 256, email address in block 258, user name in block 260, password in block 262, credit card or billing information in block 264, and other information or credentials necessary to establish a profile, identity, and billing information for the user. The user agrees to the terms and conditions of using the services of application provider 130 in block 266. The user's profile is stored and maintained by application provider 130 in central database 136. The user can update his or her profile or interact with application provider 130 by entering user name 260 and password 262 in application provider graphical interface login 270, as shown in FIG. 8. The user name 260 can be any personal name, number, nickname, or email address that uniquely identifies the user and the password can be a combination of letters, numbers, and symbols assigned to or selected by the user. Accordingly, the user's profile and personal data remains secure and confidential within the central database 136 of application provider 130.

After registering a profile and logging in to the user's account, as shown in FIGS. 7 and 8, using mobile device 104, computer system 112, or communication device 118, an application store graphical interface 280 is presented to users 102, 110, or 116, as a window or screen on mobile device 104, computer system 112, or communication device 118, as shown in FIG. 9. Various options are presented to the user for searching and browsing the software applications available from application provider 130 stored in application database 134 through application store graphical interface 280. For example, the user can choose to review the various application categories 282. Application categories include broad categories such as games, business, education, entertainment, finance, health and fitness, music, news, shopping, or the like. Application categories also include sub-categories or sub-genres. A user can also choose to review the most popular applications 284. A user can also review sponsored or featured applications 286. Alternatively, a user can choose to review the top free applications 288 or the top paid applications 290. A user can also choose to simply browse by application name in block 292, or search applications using keyword queries in block 294. Application store graphical interface 280 also includes other options or choices for reviewing the various applications available from application provider 130 and stored in application database 134.

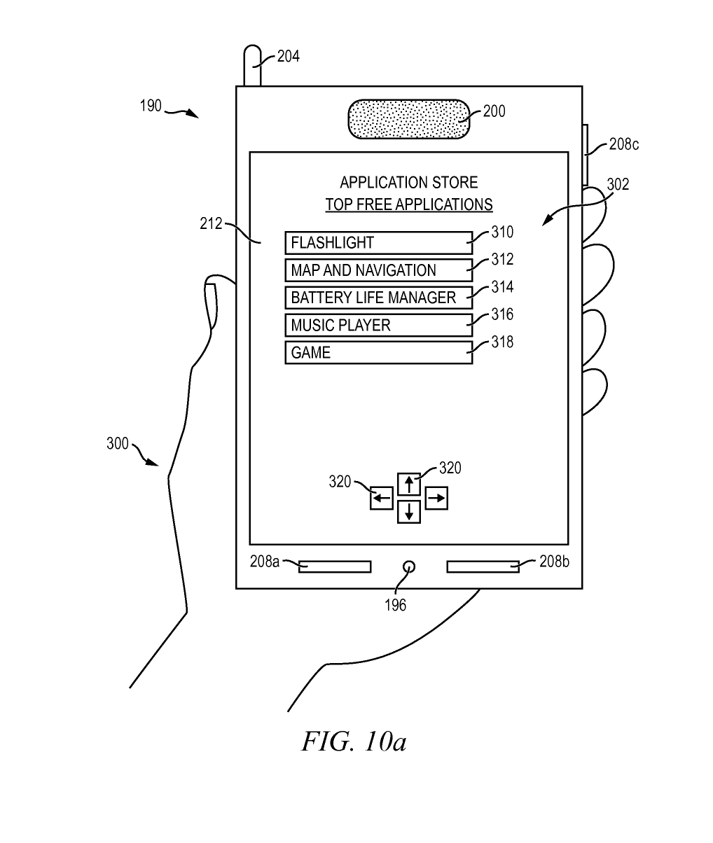

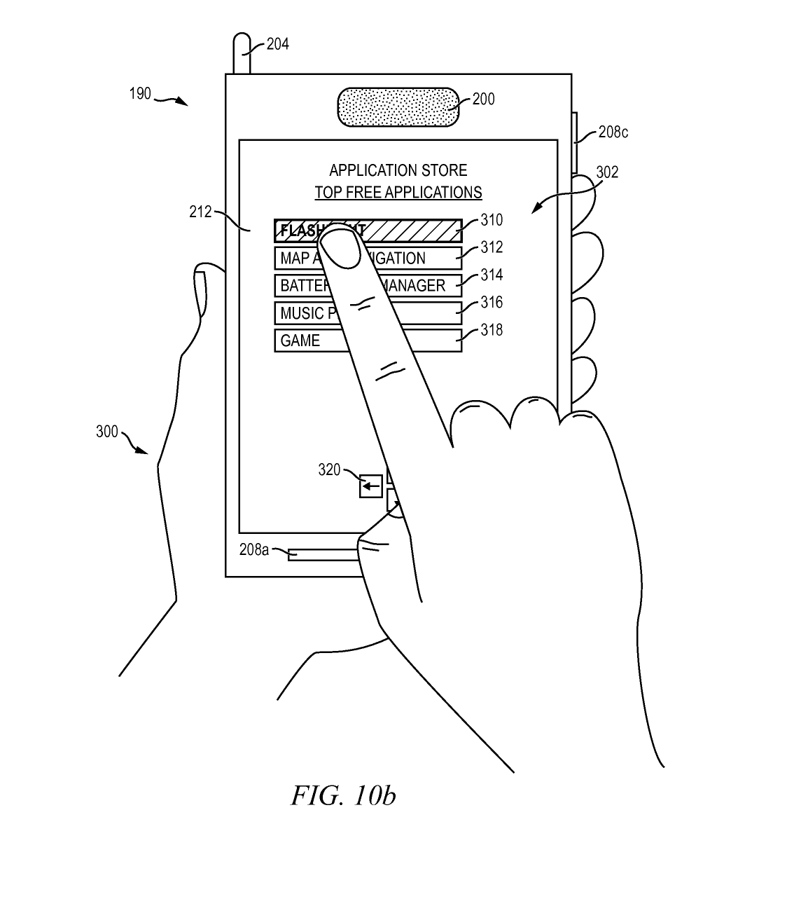

In FIG. 10a, after completing the registration process illustrated in FIGS. 7 and 8, a user 300 using mobile device 190 chooses to browse the top free applications 288 from FIG. 9. An application store graphical interface 302 for browsing the most popular free applications is displayed on touch screen 212. The top free applications, which are indexed and stored in application database 134, are listed on application store graphical interface 302. For example, the top free applications displayed in application store graphical interface 302 include a flashlight application 310, capable of activating the external light source 220 of mobile device 190 to illuminate the environment of a user. The top free applications displayed in application store graphical interface 302 also include a map and navigation application 312 capable of tracking the location of mobile device 190 using GPS receiver 230 and providing a graphical representation of the location of mobile device 190 on touchscreen 212. The top free applications displayed in application store graphical interface 302 also include a battery life manager 314, capable of monitoring and optimizing the electrical performance and battery life of mobile device 190 by controlling the status of hardware and software installed in mobile device 190. The top free applications displayed in application store graphical interface 302 also include a music player 316 capable of playing music stored in electronic format on mass storage device 226 or electronic memory 228 of mobile device 190, or downloaded from a server or computer system in electronic communication with data network 20. The top free applications displayed in application store graphical interface 302 also include a game application 318 capable of sensing user input through touchscreen 212 and providing a graphically entertaining display on touchscreen 212 in response to user input. User 300 navigates through application store graphical interface 302 using navigation icons 320.

In FIG. 10b, as user 300 browses the top free applications in application store graphical interface 302, user 300 experiences a power outage and the electricity in the home of user 300 goes out. User 300 recognizes flashlight application 310 listed on application store graphical interface 302 and decides to download and install flashlight application 310 onto mobile device 190. User 300 selects flashlight application 310 and flashlight application 310 begins to transfer through data network 20 from application database 134 to mass storage device 226 or electronic memory 228 of mobile device 190. Alternatively, user 300 can transfer flashlight application 310 onto mobile device 190 from another computer system in a hard-wired or wireless configuration, or from external computer-readable media. Flashlight application 310 is a computer program product containing computer readable program code embodied in or recorded on a computer readable or usable medium. The computer readable program code of flashlight application 310 is adapted to implement a series of instructions or a method for controlling the hardware and software components of a computer system or mobile device to illuminate a light source on a mobile device. The computer readable program code of flashlight application 310 is further adapted to implement a series of instructions or a method for influencing and controlling a commerce system through an electronic communication network.

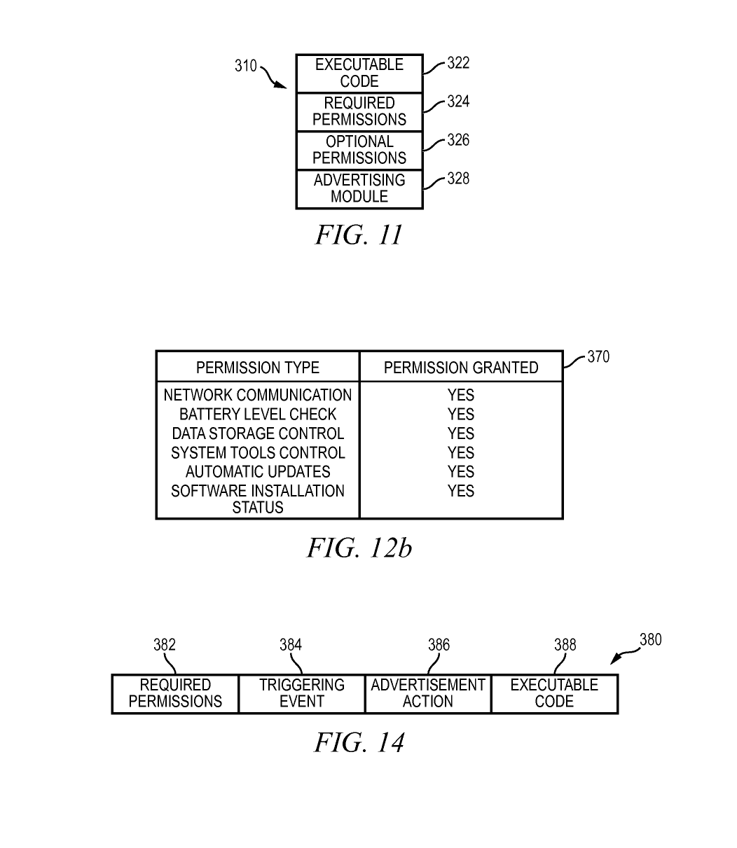

As shown in FIG. 11, flashlight application 310 includes executable code 322, which represents a computer program product containing non-transitory computer readable program code embodied in a computer program product. Executable code 322 operates as logical functions or a series of executable instructions for performing the functions of flashlight application 310, such as activating and adjusting the brightness of light source 220 in response to inputs from a user. Executable code 322 can also contain computer readable program code embodied in a computer program product operating as logical functions or a series of executable instructions for displaying advertisements, notifications, promotional text, for executing the functionality of software applications, or for generally performing advertisement actions. Executable code 322 can be modified or updated to change the functionality of flashlight application 310 and to change the advertisement actions performed by flashlight application 310 and the circumstances under which the advertisement actions are performed.

Flashlight application 310 also includes a list or set of required execution privileges or required permissions 324. Required permissions 324 define the scope of the components, functions, and features of mobile device 190, which flashlight application 310 must be permitted to control or interact with in order for flashlight application 310 to function. Flashlight application 310 further includes a list or set of optional execution privileges or optional permissions 326. Optional permissions 326 define the scope of the components, functions, and features of mobile device 190, which flashlight application 310 does not necessarily need to be permitted to control or interact with for the basic functions of flashlight application 310 to operate. The optional permissions 326 can be optionally included by the software developer of flashlight application 310 in order to provide additional features or functionality for flashlight application 310.

Flashlight application 310 also includes advertising module 328. Advertising module 328 is computer readable program code embodied in a non-transitory computer readable or computer usable medium and serves as the logical engine for monitoring the components and status of a mobile device and user behavior according to the scope of a set of permissions defined by the user. Advertising module 328 is also the logical engine for executing other non-transitory computer readable program code from advertisements embedded within or associated with flashlight application 310. The non-transitory computer readable program code from such embedded advertisements is configured or adapted to implement a series of instructions or a method for performing an advertisement action, such as displaying advertisement notifications, promotional text, determining whether and when to display an advertisement, determining compatible advertisements, executing logical functions, running a trial version of a separate software application, or generally executing a series of instructions intended to promote a product or service. Advertising module 328 can be modified or updated to change the advertisement actions performed by advertising module 328 and the circumstances under which the advertisement actions are performed.

The various pieces or components of flashlight application 310, including executable code 322, required permissions 324, optional permissions 326, and advertising module 328 can be incorporated into one or more data files for flashlight application 310 and are stored on mass storage device 226 or electronic memory 228 of mobile device 190. In another embodiment, portions of flashlight application 310 are stored externally on a computer system in electronic communication with mobile device 190 through data network 20.

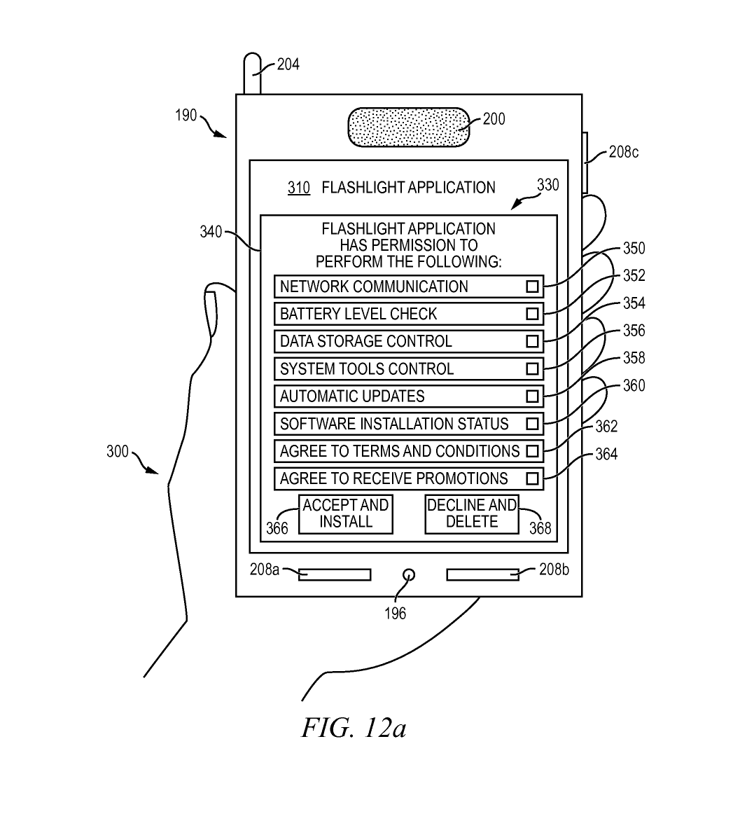

FIG. 12a shows installation screen graphical interface 330 of flashlight application 310 displayed on touchscreen 212 of mobile device 190. A list of approved permissions 340 is requested on installation screen graphical interface 330 to request user 300 select and approve individual permissions and privileges for flashlight application 310 to control and monitor the status or state of mobile device 190 according to required permissions 324 and optional permissions 326. For example, user 300 is asked with individual permission request 350 to give permission for flashlight application 310 to engage in network communication with data network 20. User 300 is asked with individual permission request 352 for permission for flashlight application 310 to perform a battery level check. User 300 is asked with individual permission request 354 for permission for flashlight application 310 to perform data storage control (i.e., to read and write data to mass storage device 226 or electronic memory 228). User 300 is asked with individual permission request 356 for permission for flashlight application 310 to perform system tools control (i.e., to prevent mobile device 190 from turning off while flashlight application 310 is running). User 300 is asked with individual permission request 358 for permission for flashlight application 310 to perform automatic software updates. User 300 is asked with individual permission request 360 for permission for flashlight application 310 to check and monitor the status of any software installations onto mobile device 190.

The developer of flashlight application 310 can choose to make some or all of the permissions settings optional, depending on whether the permissions are necessary for flashlight application 310 to function. User 300 is also asked to agree to the terms and conditions of using flashlight application 310 in block 362. User 300 is also asked to agree to receive promotions in block 364. Promotions can include offers, deals, or advertisements for products or services. If user 300 indicates agreement to each of the required permission settings, the terms and conditions, and to receive promotional notifications, user 300 can accept the permissions and continue installing flashlight application 310 by touching icon 366. Alternatively, user 300 can decline to accept the permission requests and optionally delete flashlight application 310 from mobile device 190 by tapping icon 368. In another embodiment, the permission settings are accepted or declined by user 300 prior to downloading or delivering flashlight application 310 onto mobile device 190.

If user 300 accepts some or all of the permission requests of flashlight application 310, the responses to the permission requests are saved in mass storage device 226 or electronic memory 228 of mobile device 190. In one embodiment, the responses to the permission requests are saved in mass storage device 226 or electronic memory 228 as permission data 370, as shown in FIG. 12b. In another embodiment, permission data 370 is uploaded or transferred to a computer system managed and maintained by application provider 130 or the developer of flashlight application 310 through data network 20. Permission data 370 indicates each type of permission request made by the software application, and the corresponding response of the user. Permission data 370 indicates user 300 was asked to give permission for flashlight application 310 to engage in network communication, perform a battery level check, perform data storage control, perform system tools control, perform automatic updates, and check the status of any software installations. Permission data 370 also indicates user 300 gave permission for each of the permission requests.

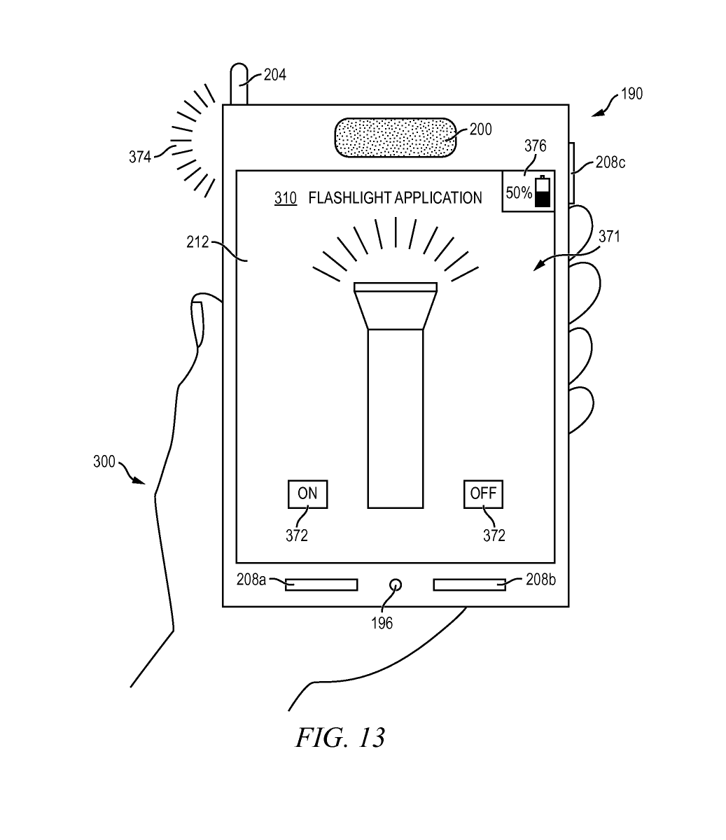

After flashlight application 310 is installed on mobile device 190 and flashlight application 310 has established permission settings or created permission data 370, user 300 can begin using flashlight application 310. User 300 can activate flashlight application 310 using mobile device 190 to illuminate the environment around mobile device 190, as shown in FIG. 13. User 300 interacts with flashlight application graphical interface 371 displayed on touchscreen 212 to turn light source 220 (shown in FIG. 6c) on and off using icons 372 to create light 374 or perform other functionality with mobile device 190 made possible by flashlight application 310. Because flashlight application 310 requested and received permission to check the status of the battery level of mobile device 190, flashlight application 310 indicates, in battery-status indicator icon 376, the amount of energy remaining in battery 206. User 300 can continue to use flashlight application 310 until deciding to stop or until the energy in battery 206 drains completely.

Meanwhile, after flashlight application 310 is installed on mobile device 190, advertising module 328 of flashlight application 310 initiates a search to find compatible advertisements. As discussed previously, advertisement database 144 stores and indexes advertisements from advertiser 140, along with relevant data for the advertisement. FIG. 14 shows an exemplary advertisement 380, which is stored in advertisement database 144 from FIG. 4. Advertisement 380 contains a required permissions list 382 for obtaining information to indicate a triggering event within triggering event list 384. Triggering events include changes in the state or status of a mobile device, or input from a user. Examples of triggering events on a mobile device include installation of a new software application, deleting a software application, low battery power, movement of the mobile device, receiving a voice mail, browsing the internet, internal or external temperature of a mobile device, arriving at a location, stopping or starting a software application, or any other user input, state, or environmental condition of a mobile device that can be measured or monitored using the components and software installed in the mobile device.

Advertisement 380 also contains an advertisement action list 386. Advertisement action list 386 includes a list of advertisement actions to occur in the event that a corresponding triggering event defined in triggering event list 384 occurs. Advertising actions describe a response that should occur when a triggering event occurs. Examples of advertisement actions include displaying promotional text for a product or service, displaying a text notification, playing audio or video to promote a product or service, executing a separate software application, or any other action that could be performed using a mobile device to promote a product or service.

Advertisement 380 also includes optional pieces of executable code 388. Executable code 388 is a computer program product containing computer readable program code embodied in a tangible or non-transitory computer readable or usable medium. Executable code 388 is configured or adapted to implement a series of instructions or a method for performing an advertisement action, such as displaying advertisement notifications or promotional text, determining whether and when to display an advertisement, determining compatible advertisements, executing logical functions, running a trial version of a software application, or generally executing a series of instructions intended to promote a product or service. Executable code 388 is configured to be embedded within or associated with a software application and executed by an advertising module of a software application. Advertisement 380 can be a single data file stored on a single computer system, or can include multiple data files stored on separate computer systems that are in electronic communication through data network 20.

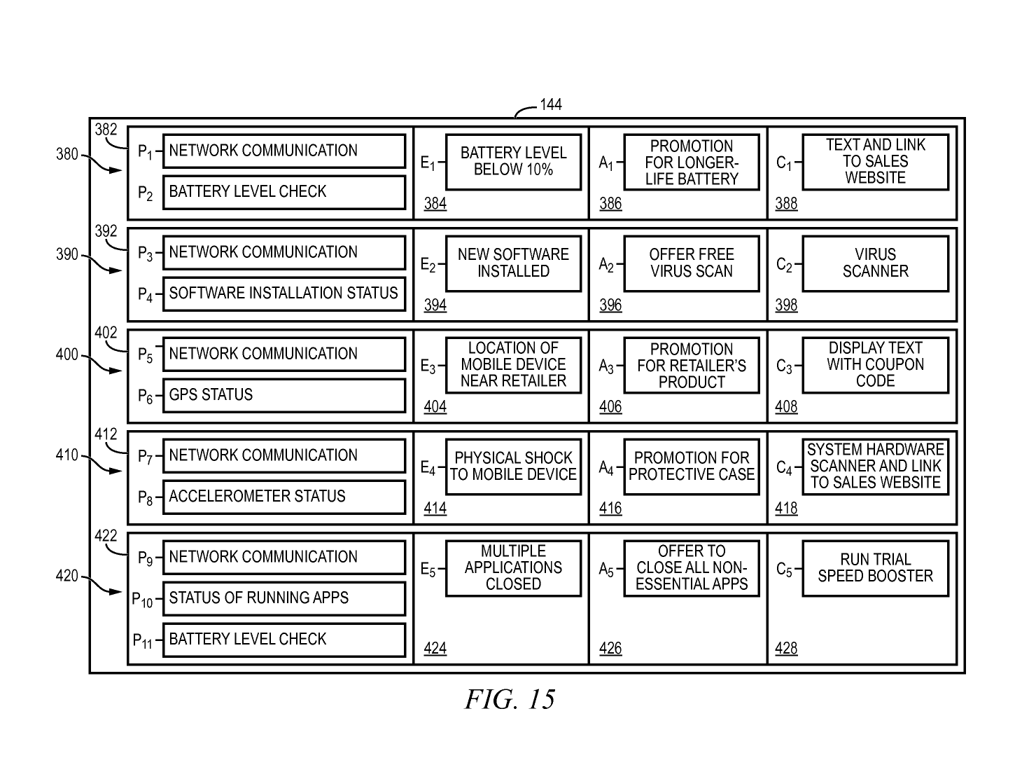

FIG. 15 shows further detail of advertisement database 144 from FIG. 4 including a plurality of advertisements 380, 390, 400, 410, and 420. Advertisements 390, 400, 410, and 420 are configured similar to advertisement 380. Required permissions list 382 of advertisement 380 includes permissions P1 and P2. Permission P1 requires a user to agree to allow a software application to engage in network communication. Permission P2 requires a user to agree to allow a software application to check the status of the battery level of a user's mobile device. Triggering event list 384 of advertisement 380 includes triggering event E1, indicating that advertisement A1 within advertisement action list 386 occurs when the battery level of a user's mobile device drops below 10%. Advertisement action list 386 of advertisement 380 can include displaying advertisement notifications or promotional text, determining whether and when to display an advertisement, determining compatible advertisements, executing logical functions, running a trial version of a software application, or generally executing a series of instructions intended to promote a product or service. Action A1 of advertisement action list 386 indicates that a promotion for a longer-life battery is displayed on a user's mobile device after the occurrence of triggering event E1.

Executable code 388 of advertisement 380 can be embedded within or associated with a software application and can be executed by an advertising module of the software application. Executable code 388 is computer readable program code embodied in a non-transitory computer readable or computer usable medium. Executable code 388 is configured or adapted to implement a series of instructions or a method for performing advertisement action A1. Executable code 388 includes a set of instructions or embeddable software code C1 containing computer readable program code embodied in a computer program medium, which includes program code instructions for displaying promotional text and a link to a sales website for a longer-life battery on a user's mobile device.

Required permissions list 392 of advertisement 390 includes permissions P3 and P4. Permission P3 requires a user to agree to allow a software application to engage in network communication. Permission P4 requires a user to agree to allow a software application to check the status of any software installations that occur on a user's mobile device. Triggering event list 394 of advertisement 390 includes triggering event E2, indicating that advertisement action A2 of advertisement action list 396 occurs when new software is installed on the user's mobile device. Advertisement action list 396 of advertisement 390 can include displaying advertisement notifications or promotional text, determining whether and when to display an advertisement, determining compatible advertisements, executing logical functions, running a trial version of a software application, or generally executing a series of instructions intended to promote a product or service. Action A2 of advertisement action list 396 indicates that an offer to run a free virus scan of newly installed software is displayed on a user's mobile device after the occurrence of triggering event E2.

Executable code 398 of advertisement 390 can be embedded within or associated with a software application and can be executed by an advertising module of the software application. Executable code 398 is computer readable program code embodied in a non-transitory computer readable or usable medium. Executable code 398 is configured or adapted to implement a series of instructions or a method for performing advertisement action A2. Executable code 398 includes a set of instructions or embeddable software code C2 containing computer readable program code embodied in a computer program medium, which includes program code instructions for displaying text on a user's mobile device. Software code C2 also contains computer readable program code embodied in a computer program medium including instructions to execute a virus scan of newly installed software on a user's mobile device.

Required permissions list 402 of advertisement 400 includes permissions P5 and P6. Permission P5 requires a user to agree to allow a software application to engage in network communication. Permission P6 requires a user to agree to allow a software application to check the status of the GPS receiver of the user's mobile device. Triggering event list 404 of advertisement 400 includes triggering event E3, indicating that advertisement action A3 of advertisement action list 406 occurs when a user's mobile device approaches the location of a retailer. Advertisement action list 406 of advertisement 400 can include displaying advertisement notifications or promotional text, determining whether and when to display an advertisement, determining compatible advertisements, executing logical functions, running a trial version of a software application, or generally executing a series of instructions intended to promote a product or service. Action A3 of advertisement action list 406 indicates that a promotion for a retailer's products or services is displayed on a user's mobile device after the occurrence of triggering event E3.

Executable code 408 of advertisement 400 can be embedded within or associated with a software application and can be executed by an advertising module of a software application. Executable code 408 is computer readable program code embodied in a non-transitory computer readable or computer usable medium. Executable code 408 is configured or adapted to implement a series of instructions or a method for performing advertisement action A3. Executable code 408 includes a set of instructions or embeddable software code C3 containing computer readable program code embodied in a computer program medium, which includes program code instructions for displaying promotional text with a coupon code for a retailer's products or services on a user's mobile device.

Required permissions list 412 of advertisement 410 includes permissions P7 and P8. Permission P7 requires a user to agree to allow a software application to engage in network communication. Permission P8 requires a user to agree to allow a software application to check the status of the accelerometer of the user's mobile device. Triggering event list 414 of advertisement 410 includes triggering event E4, indicating that advertisement action A4 of advertisement action list 416 occurs when a user's mobile device experiences a sudden physical shock such as being dropped or knocking into another physical object. Advertisement action list 416 of advertisement 410 can include displaying advertisement notifications or promotional text, determining whether and when to display an advertisement, determining compatible advertisements, executing logical functions, running a trial version of a software application, or generally executing a series of instructions intended to promote a product or service. Action A4 of advertisement action list 416 indicates that a promotion for a protective case compatible with a user's mobile device and for a system hardware scan is displayed on the mobile device after the occurrence of triggering event E4.

Executable code 418 of advertisement 400 can be embedded within or associated with a software application and can be executed by an advertising module of the software application. Executable code 418 is computer readable program code embodied in a non-transitory computer readable or usable medium. Executable code 418 is configured or adapted to implement a series of instructions or a method for performing advertisement action A4. Executable code 418 includes a set of instructions or embeddable software code C4 containing computer readable program code embodied in a computer program medium, which includes program code instructions for displaying promotional text and a link to a sales website for a protective case compatible with a user's mobile device. Software code C4 also contains computer readable program code embodied in a computer program medium including program code instructions for performing a system hardware check to determine whether any damage has occurred to the hardware of a mobile device.

Required permissions list 422 of advertisement 420 includes permissions P9, P10, and P11. Permission P9 requires a user to agree to allow a software application to engage in network communication. Permission P10 requires a user to agree to allow a software application to check the status of which applications are running on a mobile device. Triggering event list 424 of advertisement 420 includes triggering event E5, indicating that advertisement action A5 of advertisement action list 426 occurs when multiple software applications are recently closed or terminated.

Advertisement action list 426 of advertisement 420 can include displaying advertisement notifications or promotional text, determining whether and when to display an advertisement, determining compatible advertisements, executing logical functions, running a trial version of a software application, or generally executing a series of instructions intended to promote a product or service. Action A5 of advertisement action list 426 indicates that an offer to close all non-essential software applications is displayed on the mobile device after the occurrence of triggering event E5.

Executable code 428 of advertisement 420 can be embedded within or associated with a software application and can be executed by an advertising module of the software application. Executable code 428 is computer readable program code embodied in a non-transitory computer readable or usable medium. Executable code 428 is configured or adapted to implement a series of instructions or a method for performing advertisement action A5. Executable code 428 includes sets of instructions or embeddable software code C5, which includes computer readable program code embodied in a tangible or non-transitory computer readable or computer usable medium. Software code C5 includes program code instructions for running a trial version of a speed boosting application capable of closing or terminating all non-essential software applications running on a mobile device.

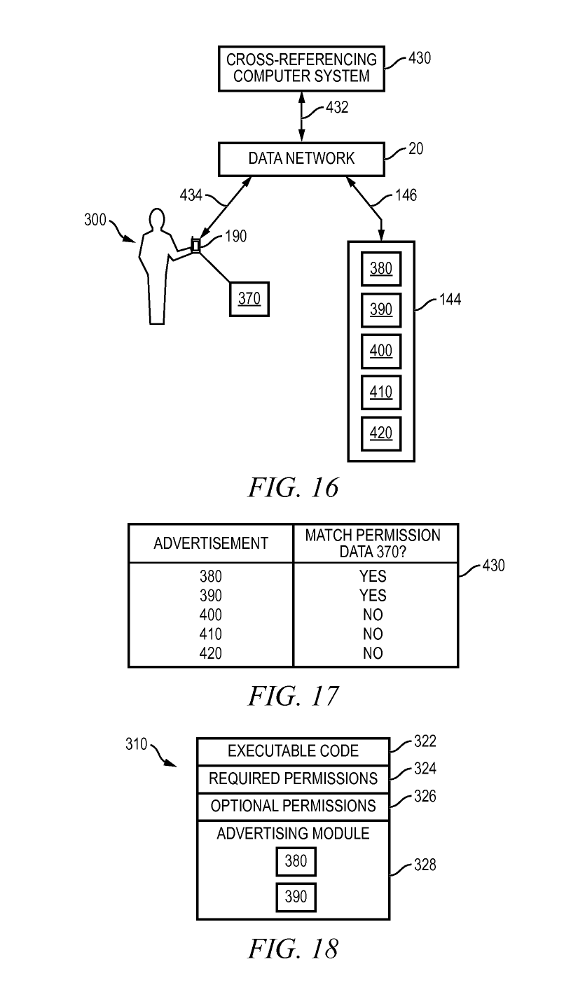

In FIG. 16, a cross-referencing computer system 430 is in electronic communication with data network 20 over communication channel or link 432. Communication channel 432 is bi-directional and transmits data between cross-referencing computer system 430 and data network 20 in a hard-wired or wireless configuration. Cross-referencing computer system 430 can be configured to have all or some of the components as shown for computer system 150 in FIG. 5. In one embodiment, cross-referencing computer system 430 is a separate computer system managed by application provider 130 or advertiser 140 through data network 20. Alternatively, cross-referencing computer system 430 can be integrated into a computer system managed by advertiser 140 or application provider 130. In another embodiment, cross-referencing computer system 430 is embedded or installed as a separate software application within mobile device 190 of user 300. In another embodiment, cross-referencing computer system 430 is embedded or installed as part of an advertising module of a software application such as advertising module 328 of flashlight application 310.

Mobile device 190 is in electronic communication with data network 20 over communication channel or link 434. Communication channel 434 is bi-directional and transmits data between mobile device 190 and data network 20 in a hard-wired or wireless configuration. Permission data 370 from FIG. 12b is stored on mass storage device 226 or electronic memory 228 of mobile device 190.

Cross-referencing computer system 430 compares permission data 370 with permissions P1-P11 of advertisements 380, 390, 400, 410, and 420 stored in advertisement database 144 to determine whether any of the permissions lists 382, 392, 402, 412, or 422 are consistent or compatible with permission data 370. As discussed with reference to FIG. 15, permission lists 382, 392, 402, 412, and 422 require a user to agree to allow a software application to engage in network communication (permissions P1, P3, P5, P7, and P9). Permission list 382 also requires a user agree to allow a software application to monitor the status of the battery level of a user's mobile device or computer system (permission P2). Permission list 392 requires a user to agree to allow a software application to monitor the status of any software installations that occur on a user's mobile device (permission P4). Permission list 402 requires a user to agree to allow a software application to monitor the status of the GPS receiver of a user's mobile device or computer system (permission P6). Permission list 412 requires a user to agree to allow a software application to monitor the status of the accelerometer of a user's mobile device or computer system (permission P8). Permission list 422 requires a user to agree to allow a software application to monitor the status of running software applications (permission P10), and monitor the status of the battery level of a user's mobile device or computer system (permission P11).

As discussed with reference to FIG. 12b, permission data 370 indicates user 300 agreed to the required permissions of permission lists 382 and 392. Cross-referencing computer system 430 acknowledges that user 300 has agreed to allow flashlight application 310 to engage in network communication (matching permissions P1, P3, P5, P7, and P9), battery level check (matching permissions P2, and P11), and software installation status (matching permission P4). On the other hand, user 300 has not agreed to allow flashlight application 310 to access GPS status (matching permission P6), to allow flashlight application 310 to monitor accelerometer status (matching permission P8), or to allow flashlight application 310 to monitor the status of running software applications (matching permission P10).

Thus, as shown in FIG. 17, cross-referencing computer system 430 determines that advertisements 380 and 390 match, or are compatible with the permissions defined by permission data 370 associated with flashlight application 310. By contrast, cross-referencing computer system 430 determines that advertisements 400, 410, and 420 do not match, or are not compatible with the permissions defined in permission data 370 associated with flashlight application 310.

Because advertisements 380 and 390 are compatible with permission data 370 of flashlight application 310, flashlight application 310 initiates a process to transfer advertisements 380 and 390 to mobile device 190. In another embodiment, the process to transfer advertisements 380 and 390 to mobile device 190 is initiated by cross-referencing computer system 430 or another computer system in electronic communication with data network 20. Advertisements 380 and 390 are downloaded to mobile device 190 through data network 20. Advertisements 380 and 390 can be stored as separate data files or incorporated into advertising module 328.

FIG. 18 shows flashlight application 310 after incorporating advertisements 380 and 390 into advertising module 328. By contrast, because advertisements 400, 410, and 420 are not compatible with permission data 370, advertisements 400, 410, and 420 are not downloaded to mobile device 190 and are not incorporated into advertising module 328.

After incorporating advertisements 380 and 390 into advertising module 328 of flashlight application 310, advertiser 140 or application provider 130 can later choose to modify advertisements 380 and 390, or upload additional advertisements that are compatible with flashlight application 310 to advertisement database 144. Thus, advertising module 328 of flashlight application 310 continues to communicate periodically or regularly with application database 144 to ensure that advertisements 380 and 390 are up-to-date, and to check for additional potential advertisements. If new versions of advertisements 380 and 390 are available, the updated versions are downloaded automatically or with permission from user 300 to mobile device 190 and incorporated into advertising module 328. Additional compatible advertisements can also be downloaded automatically or with permission from user 300 to mobile device 190 and incorporated into advertising module 328.

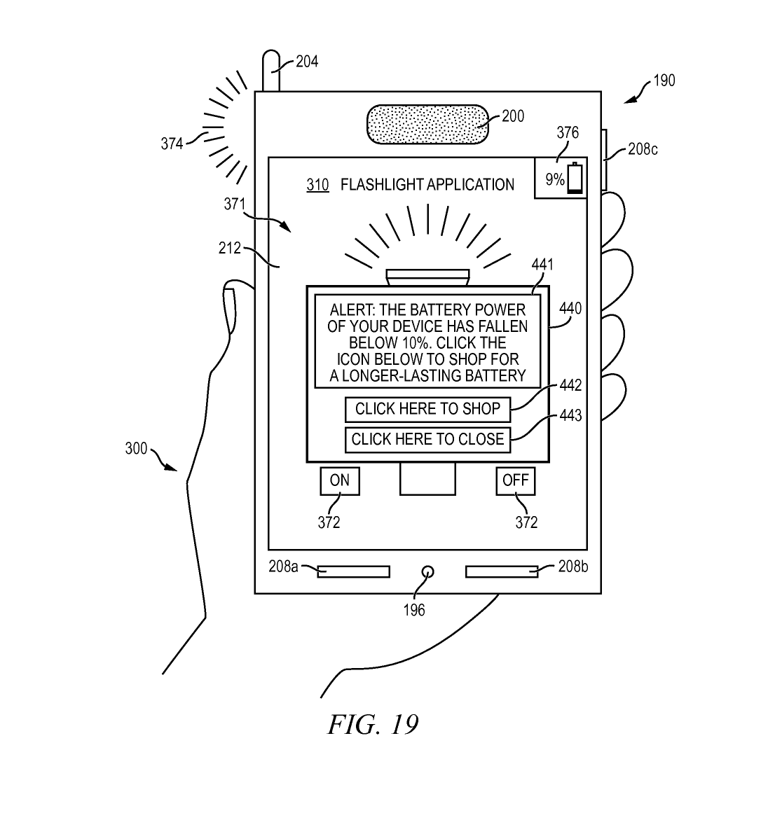

Meanwhile, user 300 continues to engage with flashlight application 310 on mobile device 190, as shown in FIG. 19. User 300 turns light source 220 on and off using icons 372 of flashlight application graphical interface 371 to illuminate the environment around mobile device 190. Simultaneously, advertising module 328 of flashlight application 310 monitors the status of mobile device 190 and the components of mobile device 190 according to the required permissions list 324 and optional permissions list 326 of flashlight application 310.

As user 300 engages with flashlight application 310, the power level of battery 206 decreases below 10%, as indicated by battery-status indicator icon 376. Thus, triggering event E1 within triggering event list 384 associated with advertisement 380 has occurred, i.e., the battery level of mobile device 190 has dropped below 10%. In response to triggering event E1, advertising module 328 of flashlight application 310 initiates software code C1 of advertisement 380 to perform action A1 to layer advertisement notification 440 over flashlight application graphical interface 371. Advertisement notification 440 includes promotional text 441 and a hyperlink icon 442 linking to a sales website for a longer-life battery.

User 300 can choose to select hyperlink icon 442 to open a separate browser window to display the sales website and purchase the longer-life battery through data network 20. Advertisement notification 440 also has an icon button 443 for closing the window of advertisement notification 440. User 300 can choose to ignore or dismiss advertisement notification 440 by tapping or clicking icon button 443. Alternatively, user 300 can choose to shop for an extended-life or longer-lasting mobile device battery by clicking or tapping hyperlink icon 442. If user 300 chooses to shop for a longer-lasting battery by tapping hyperlink icon 442, flashlight application 310 can initiate a separate Internet browsing application, or an Internet browsing application embedded within flashlight application 310, to display a website selling the longer-lasting battery.

Advertising module 328 of flashlight application 310 controls the commerce system by influencing the purchasing decisions of user 300 by presenting user 300 with a promotional advertisement notification in the context of the environment or status of mobile device 190. A plurality of advertisements 380, 390, 400, 410, and 420 is stored in an advertisement database 144. Similarly, a plurality of software applications is stored in an application database 134. User 300 chooses to install one of the software applications, flashlight application 310, onto mobile device 190. Flashlight application 310 is delivered through data network 20 and installed on mobile device 190. Flashlight application 310 requests user 300 to select from a list of required permissions 324, and user 300 is presented with choices for selecting individual permissions to monitor the components, the status, and the environment of mobile device 190. The responses to the list of required permissions 324 is saved as permission data 370, indicating the type of permission request and the corresponding response of user 300.

A cross-referencing computer system 430 compares permission data 370 to a required permissions list of each advertisement stored in advertisement database 144 to determine whether any of the advertisements are compatible with flashlight application 310. Cross-referencing computer system 430 determines that advertisements 380 and 390 are compatible with flashlight application 310, because required permissions list 382 of advertisement 380 and required permissions list 392 of advertisement 390 match permission data 370. In other words, cross-referencing computer system 430 determines from permission data file 370 that user 300 has agreed to permissions P1 and P2 of advertisement 380 and permissions P3 and P4 of advertisement 390. Thus, cross-referencing computer system 430 determines that advertisements 380 and 390 are compatible advertisements, and advertisements 380 and 390 are delivered through data network 20 to mobile device 190.

After advertisements 380 and 390 are delivered to mobile device 190, advertising module 328 of flashlight application 310 monitors the status of mobile device 190, including the status and environment of the components of mobile device 190 according to permission data 370, to detect the occurrence of a triggering event E1 or E2 of advertisements 380 and 390. When triggering event E1 occurs, i.e., the battery level of mobile device 190 drops below 10%, advertisement 380 executes an instruction of software code C1 to perform action A1, and to perform a logical function to display advertisement notification 440 including promotional text 441 and a hyperlink icon 442 linking to a sales website for a longer-life battery.

By displaying advertisement notification 440 in the context of triggering event E1, advertisement notification 440 is targeted to a consumer that is more likely to be interested in purchasing a particular product at the moment the advertisement is displayed. Specifically, advertising module 328 of flashlight application 310 displays advertisement notification 440, which promotes a longer-lasting battery, to user 300 in the context of low battery power of battery 206. Thus, user 300 is more inclined to shop for an extended-life or longer-lasting battery than would otherwise be the case if user 300 were not currently experiencing low battery power of battery 206. The purchasing decisions of user 300 are therefore influenced or controlled by delivering an advertisement that is relevant to user 300 and is triggered by the context of the environment or status of mobile device 190 or user 300.

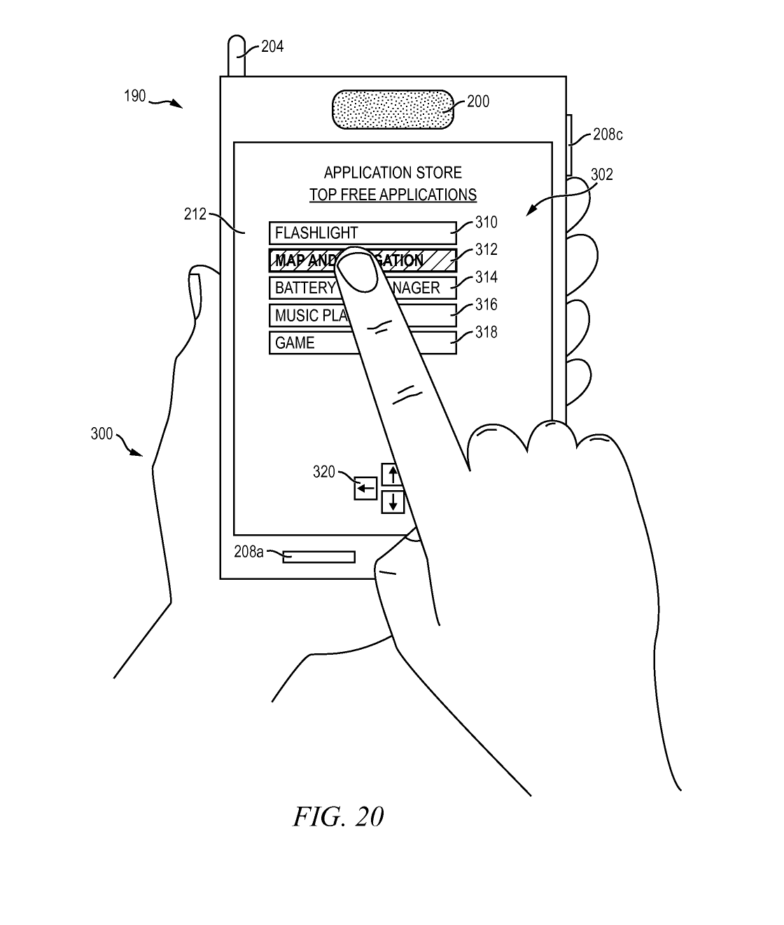

After installing flashlight application 310 onto mobile device 190 and downloading updates to incorporate advertisements 380 and 390 into advertising module 328, user 300 decides to visit a café to enjoy a cup of coffee. Continuing from FIG. 10a, user 300 returns to application store graphical interface 302 using mobile device 190 to browse additional software applications that can be helpful for locating a nearby café. User 300 selects map and navigation application 312, as shown in FIG. 20, and map and navigation application 312 is downloaded onto mass storage device 226 or electronic memory 228 of mobile device 190 through data network 20.

Map and navigation application 312 is a computer program product, comprising computer readable program code embodied in or recorded on a tangible or non-transitory computer readable or computer usable medium. The computer readable program code of map and navigation application 312 is adapted to implement a series of instructions or a method for controlling the hardware and software components of a computer system or mobile device to provide a graphical display with an interactive map on the mobile device. The computer readable program code of map and navigation application 312 is also adapted to implement a method of controlling a commerce system through an electronic communication network.

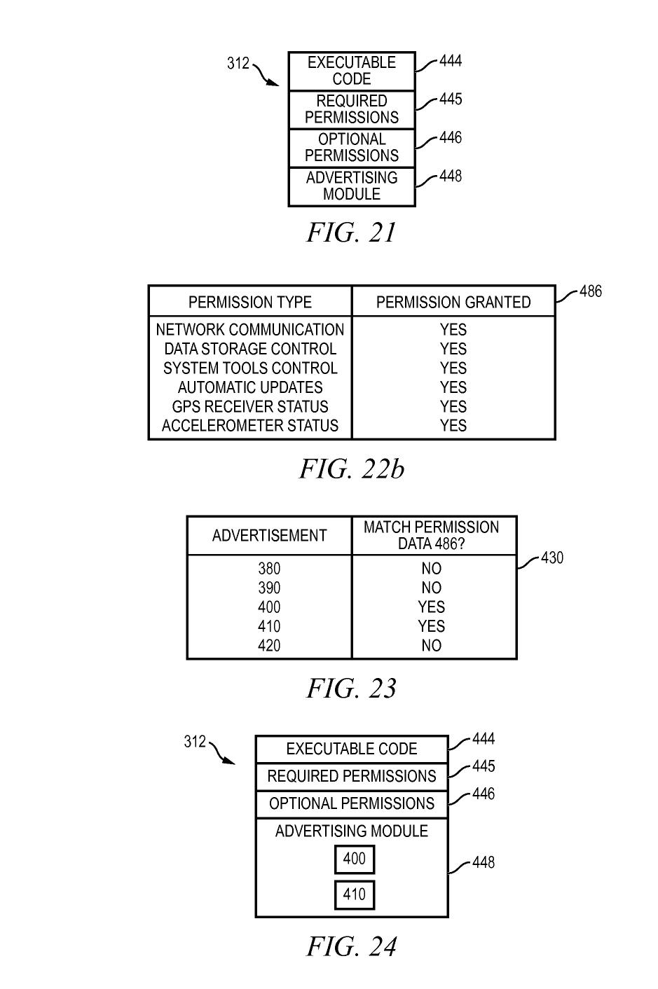

The computer readable program code of map and navigation application 312 is embodied in one or more data files and is delivered from advertisement database 144 through data network 20 to mobile device 190 of user 300. Alternatively, user 300 can transfer map and navigation application 312 onto mobile device 190 from another computer system in a hard-wired or wireless configuration, or from external computer-readable media. As shown in FIG. 21, map and navigation application 312 includes executable code 444, which represents a computer program product containing computer readable program code embodied in a tangible or non-transitory computer readable or computer usable medium or computer program product. Executable code 444 operates as logical functions or a series of executable instructions for performing the functions of map and navigation application 312, such as graphically displaying the location of mobile device 190 relative to nearby buildings and roads. Executable code 444 also contains computer readable program code embodied in a computer program product operating as logical functions or a series of executable instructions for influencing and controlling a commerce system through an electronic network by displaying promotional notifications or generally performing advertisement actions. Executable code 444 can be modified or updated to change the functionality of map and navigation application 312. Executable code 444 can also be modified or updated to change the advertisement actions performed by map and navigation application 312 and the circumstances under which the advertisement actions are performed.

Map and navigation application 312 also includes a list or set of required execution privileges or required permissions 445. Required permissions 445 define the scope of the components, functions, and features of mobile device 190, which map and navigation application 312 must be permitted to control or interact with in order for map and navigation application 312 to function. Map and navigation application 312 further includes a list or set of optional execution privileges or optional permissions 446. Optional permissions 446 define the scope of the components, functions, and features of mobile device 190, which map and navigation application 312 does not necessarily need to be permitted to control or interact with for the basic functions of map and navigation application 312 to operate. The optional permissions 446 can be optionally included by the software developer of map and navigation application 312 in order to provide additional features or functions for map and navigation application 312.

Map and navigation application 312 also includes advertising module 448. Advertising module 448 is a computer program product containing computer readable program code embodied in a non-transitory computer readable or computer usable medium and serves as the logical engine for monitoring the components and status of a mobile device as well as user behavior according to the scope the permissions defined by the user. Advertising module 448 is also the logical engine for executing other computer readable program code from advertisements embedded within or associated with map and navigation application 312. The computer readable program code from such embedded advertisements is configured or adapted to implement a series of instructions or a method for performing an advertisement action, such as displaying advertisement notifications, promotional text, determining whether and when to display an advertisement, determining compatible advertisements, executing logical functions, running a trial version of a software application, or generally executing a series of instructions intended to promote a product or service. Advertising module 448 can be modified or updated to change the advertisement actions performed by advertising module 448 and the circumstances under which the advertisement actions are performed.

The various pieces or components of map and navigation application 312, including executable code 444, required permissions 445, optional permissions 446, and advertising module 448 can be incorporated into one or more data files for map and navigation application 312. Map and navigation application 312 is stored on mass storage device 226 or electronic memory 228 of mobile device 190. In another embodiment, portions of map and navigation application 312 are stored externally on a computer system in electronic communication with mobile device 190 through data network 20.

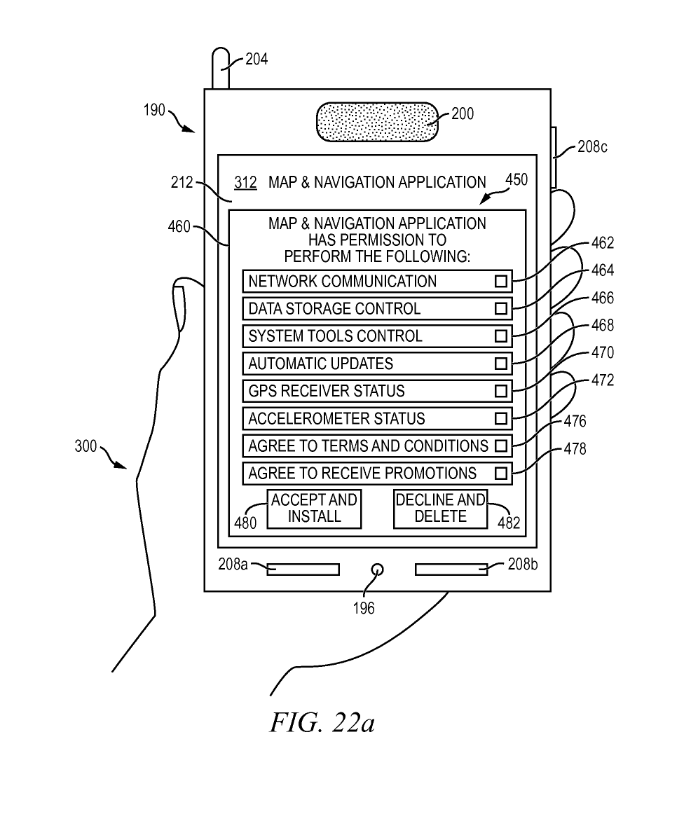

FIG. 22a shows installation screen graphical interface 450 of map and navigation application 312 displayed on mobile device 190. A list of approved permissions 460 is requested on installation screen graphical interface 450 to request user 300 select and approve individual permissions and privileges for map and navigation application 312 to monitor and control the components and status of mobile device 190. For example, user 300 is asked with individual permission request 462 to give permission for map and navigation application 312 to engage in network communication with data network 20. User 300 is asked with individual permission request 464 to give permission for map and navigation application 312 to perform data storage control (i.e., to read and write data to mass storage device 226 or electronic memory 228). User 300 is asked with individual permission request 466 for permission for map and navigation application 312 to perform system tools control (i.e., to prevent mobile device 190 from turning off while map and navigation application 312 is running). User 300 is asked with individual permission request 468 for permission for map and navigation application 312 to perform automatic software updates. User 300 is asked with individual permission request 470 for permission for map and navigation application 312 to check and monitor the status of GPS receiver 230 of mobile device 190. User 300 is asked with individual permission request 472 for permission for map and navigation application 312 to check and monitor the status of accelerometer 232 of mobile device 190.

The developer of map and navigation application 312 can choose to make some or all of the permissions settings optional, depending on whether the permissions are necessary for map and navigation application 312 to function. User 300 is also asked to agree to the terms and conditions of using map and navigation application 312 in block 476. User 300 is also asked to agree to receive promotions in block 478. Promotions include offers, deals, or advertisements for products or services. If user 300 indicates agreement to each of the required permission settings, the terms and conditions, and to receive promotional notifications, user 300 can accept the permissions and continue installing map and navigation application 312 by touching icon 480. Alternatively, user 300 can decline to accept the permission requests and optionally delete map and navigation application 312 from mobile device 190 by touching icon 482. In another embodiment, the permission settings are accepted or declined by user 300 prior to downloading or delivering map and navigation application 312 onto mobile device 190.

If user 300 accepts some or all of the permission requests of map and navigation application 312, the responses to the permission requests are saved in mass storage device 226 or electronic memory 228 of mobile device 190. In one embodiment, the responses to the permission requests are saved in mass storage device 226 or electronic memory 228 as permission data 486, as shown in FIG. 22b. In another embodiment, permission data 486 is uploaded to a computer system managed and maintained by application provider 130 or the developer of map and navigation application 312 through data network 20. The permission data 486 indicates each type of permission request made by the software application, and the corresponding response of the user. Permission data 486 indicates user 300 was asked to give permission for flashlight application 310 to engage in network communication, perform data storage control, perform system tools control, perform automatic updates, check the status of the GPS receiver, and check the status of the accelerometer. Permission data 486 also indicates user 300 gave permission for each of the permission requests.

After establishing the relevant permissions to create permission data 486, cross-referencing computer system 430 compares permission data 486 with advertisements 380, 390, 400, 410, and 420 stored in advertisement database 144 to determine whether any of the permissions lists 382, 392, 402, 412, or 422 are consistent with permission data 486, as shown in FIG. 23. Cross-referencing computer system 430 acknowledges that user 300 has agreed to allow map and navigation application 312 to engage in network communication (matching permissions P1, P3, P5, P7, and P9), monitor the status of the GPS receiver (matching permission P6), and monitor the status of the accelerometer (matching permission P8). On the other hand, user 300 has not agreed to allow map and navigation application 312 to monitor battery level (matching permission P2), to allow map and navigation application 312 to monitor the status of software installations (matching permission P4), or to allow map and navigation application 312 to monitor the status of running software applications (matching permission P10).

Accordingly, cross-referencing computer system 430 determines that advertisements 400 and 410 match, or are compatible with the permissions defined by permission data 486 associated with map and navigation application 312. By contrast, cross-referencing computer system 430 determines that advertisements 380, 390, and 420 do not match, or are not compatible with the permissions defined in permission data 486 associated with map and navigation application 312.

Because advertisements 400 and 410 are compatible with or match permission data 486 associated with map and navigation application 312, advertisements 400 and 410 are downloaded or delivered to mobile device 190 through data network 20 and incorporated into advertising module 448. FIG. 24 shows map and navigation application 312 after incorporating advertisements 400 and 410 into advertising module 448. By contrast, because advertisements 380, 390, and 420 are not compatible with permission data 486, advertisements 380, 390, and 420 are not downloaded to mobile device 190 and are not incorporated into advertising module 448.

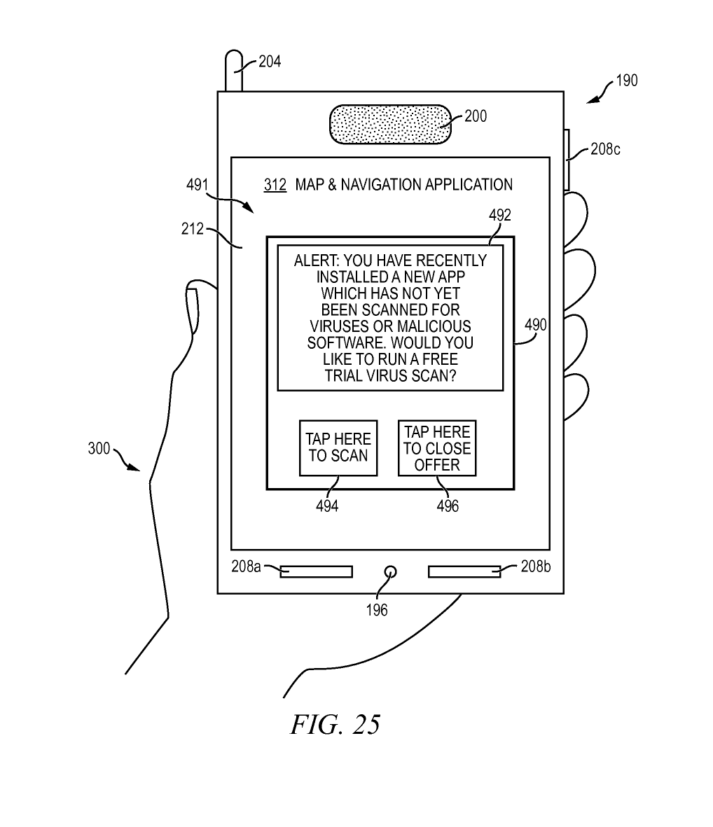

Meanwhile, advertising module 328 of flashlight application 310 monitors the status of mobile device 190 to detect a triggering event. After map and navigation application 312 is installed on mobile device 190 and map and navigation application 312 has established permission settings or created permission data 486, advertising module 328 of flashlight application 310 recognizes that triggering event E2 of advertisement 390 has occurred, i.e., a new software application has been installed on mobile device 190. In response to triggering event E2, advertising module 328 initiates software code C2 of advertisement 390 to perform action A2 to display overlay promotion or heads-up advertisement notification 490 as an overlay window or notification message layered over graphical interface 491 of map and navigation application 312, as shown in FIG. 25. Thus, advertising module 328 of flashlight application 310 initiates displaying overlay notification 490 to user 300 while user 300 is not actively engaged with using flashlight application 310, and instead is using a separate software application. Overlay notification 490 is displayed as a layer on top of the graphical interface of any application or display shown on touchscreen 212. Accordingly, advertising module 328 is capable of delivering overlay notification 490 to user 300 regardless of the activity that user 300 is performing with mobile device 190, by layering overlay notification 490 over the graphical interface of mobile device 190.

Overlay notification 490 has promotional text 492 alerting user 300 that a new software application has been installed on mobile device 190 that has not been scanned for viruses or malicious software. Promotional text 492 also asks user 300 whether user 300 would like to run a free trial virus scan of the newly installed software. Overlay notification 490 also includes an icon button 494, which user 300 can tap to initiate a virus scan of map and navigation application 312. Alternatively, user 300 can choose to ignore or dismiss overlay notification 490 by tapping or clicking icon button 496.

If user 300 chooses to initiate a virus scan of map and navigation application 312 by tapping icon button 494, flashlight application 310 can initiate the virus scan by continuing to run software code C2. Because software code C2 is embedded in flashlight application 310 through advertisement 390 and contains the software code necessary to execute a virus scan of the newly installed software, additional software need not be installed on mobile device 190 to execute the functionality of the virus scan.

Accordingly, advertisement 390, which is embedded in flashlight application 310, operates as an intelligent or smart advertisement. Advertising module 328 of flashlight application 310 is capable of sensing or monitoring the state, status, and environment of mobile device 190, i.e., whether a new software application has been installed. In response to a triggering event E2 (i.e., new software map and navigation application 312 being installed), advertising module 328 can initiate smart advertisement 390 to perform an advertisement action (i.e., display promotional text 492 advertising a product or service). Advertising module 328 is further capable of executing software code C2 of smart advertisement 390, which is a computer program product containing computer readable program code embodied in a non-transitory computer readable or computer usable medium, to perform a logical function (i.e., performing a virus scan of map and navigation application 312).

Smart advertisement 390 is embedded within flashlight application 310, and is compatible with the execution privileges of flashlight application 310. In other words, smart advertisement 390 does not require any execution privileges beyond the execution privileges user 300 has already agreed to in order to run flashlight application 310. Thus, user 300 has agreed to all of the execution privileges necessary for advertising module 328 of flashlight application 310 to monitor the status of mobile device 190 to detect triggering event E2 and to execute software code C2 of smart advertisement 390 to perform a logical function (i.e., a virus scan). Smart advertisement 390 has additional functionality, such as displaying additional promotional text to user 300 with a hyperlink to a product sales page after performing the virus scan of map and navigation application 312.

Accordingly, advertising module 328 of flashlight application 310 controls the commerce system by influencing the purchasing decisions of user 300 by presenting user 300 with a promotional advertisement notification in the context of the environment or status of mobile device 190. By displaying overlay notification 490 in the context of triggering event E2, overlay notification 490 is targeted to a consumer that is more likely be interested in purchasing a particular product at the moment the advertisement is displayed. Specifically, advertising module 328 of flashlight application 310 displays overlay notification 490, which promotes an anti-virus scanner with some functionality of the anti-virus scanner embedded within flashlight application 310. Overlay notification 490 is displayed in the context of a new software application being recently installed and has not previously been scanned for viruses for malicious software. Thus, user 300 is more likely to be inclined to run the free virus scanning trial offered by overlay notification 490 and later purchase a full version of the virus scanning software than if user 300 had not recently installed new software on mobile device 190. The purchasing decisions of user 300 are therefore influenced or controlled by delivering an advertisement that is relevant to user 300 and is triggered by the context of the environment or status of mobile device 190.

Additionally, advertising module 328 of flashlight application 310 is capable of displaying promotional text 492 of overlay notification 490 while user 300 is engaging with a separate software application, or at any time that a triggering event occurs, regardless of whether user 300 is actively engaging with flashlight application 310. Specifically, overlay notification 490 is displayed by advertising module 328 of flashlight application 310 while user 300 is engaging with map and navigation application 312. Overlay notification 490 is displayed as a window overlaying the graphical interface of map and navigation application 312. Accordingly, advertising module 328 displays overlay notification 490 even though user 300 is not actively engaging with flashlight application 310. By displaying overlay notification 490 in response to triggering event E2, at the moment that triggering event E2 occurs, the promotional text 492 of overlay notification 490 is more likely to be relevant to the purchasing decisions of user 300.

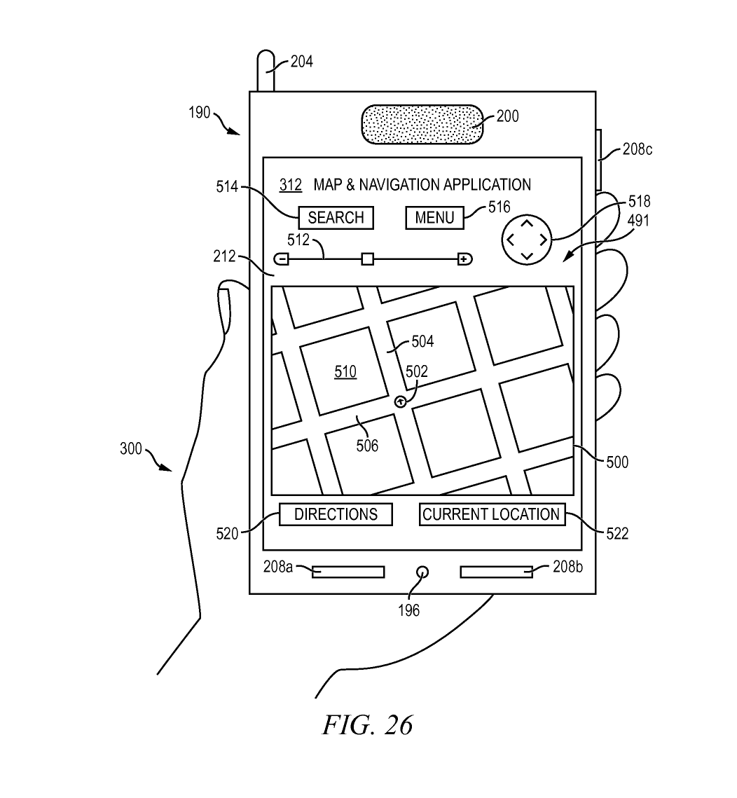

After deciding whether to perform the virus scan, as shown in FIG. 25, user 300 chooses to return to graphical interface 491 of map and navigation application 312 on mobile device 190 to help navigate to a nearby café, as shown in FIG. 26. While using map and navigation application 312, the location of mobile device 190 is determined by GPS receiver 230 (shown in FIG. 6c) and graphical interface 491 of map and navigation application 312 indicates the location of mobile device 190 is on local map 500 with location icon 502 relative to streets 504 and 506. Graphical interface 491 of map and navigation application 312 also displays the location of local retailer 510 on local map 500. Map and navigation application 312 communicates with one or more computer systems or servers in electronic communication with data network 20 to update information displayed on local map 500. User 300 can adjust the resolution of local map 500 using sliding scale icon 512, search for a retailer using search box 514, change settings or browse menu options using menu icon 516, move local map 510 with navigation icon 518, search for directions to a specific location using directions box 520, or center local map 500 on the current location of mobile device 190 using current location icon 522.

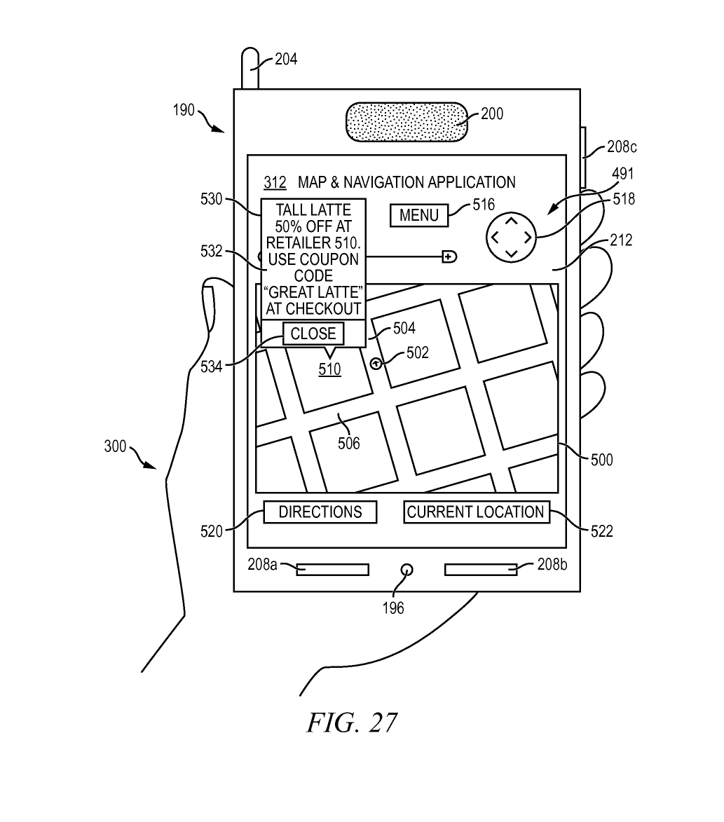

As user 300 engages with map and navigation application 312 on mobile device 190, user 300 approaches alongside retailer 510. Thus, triggering event E3 within triggering event list 404 associated with advertisement 400 has occurred, i.e., the location of mobile device 190 is nearby the location of retailer 510. In response to triggering event E3, advertisement 400 initiates software code C3 to perform action A3 to display an advertisement notification 530 including promotional text 532 offering a coupon code for a discount on the products of retailer 510, as shown in FIG. 27. Advertisement notification 530 also has an icon button 534 for closing the window of advertisement notification 530. User 300 can choose to ignore or dismiss advertisement notification 530 by tapping or clicking icon button 534. Alternatively, user 300 can choose to patronize retailer 510 and present the coupon code to retailer 510 to receive a discount on one of the products sold by retailer 510.

Accordingly, advertising module 448 of map and navigation application 312 controls the commerce system by influencing the purchasing decisions of user 300 by presenting user 300 with a promotional advertisement notification in the context of the environment or status of mobile device 190. By displaying advertisement notification 530 in the context of triggering event E3, advertisement notification 530 is targeted to a consumer that is more likely to be interested in purchasing a particular product at the moment the advertisement is displayed. Specifically, advertising module 448 of map and navigation application 312 displays advertisement notification 530, which promotes a product of retailer 510, to user 300 in the context of user 300 passing nearby retailer 510. Thus, user 300 is more likely to be inclined to patronize retailer 510 than if user 300 were not close-by or near retailer 510. The purchasing decisions of user 300 are therefore influenced or controlled by delivering an advertisement that is relevant to user 300 and is triggered in the context of the environment or status of mobile device 190 or user 300.

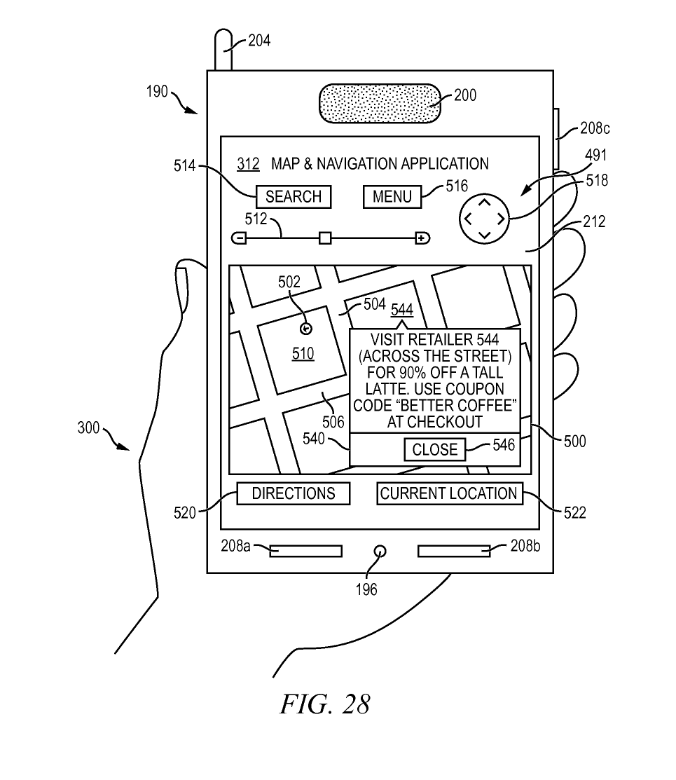

FIG. 28 illustrates an alternative scenario for displaying an advertisement to user 300 in response to a triggering event. Continuing from FIG. 26, user 300 engages with map and navigation application 312 on mobile device 190 and enters the property of retailer 510. Thus, triggering event E3 within triggering event list 404 associated with advertisement 400 has occurred, i.e., the location of mobile device 190 is nearby the location of retailer 510. In response to triggering event E3, advertisement 400 initiates software code C3 to perform action A3 to display an advertisement notification 540 including promotional text 542 offering a coupon for products of competitor retailer 544. Advertisement notification 540 also has an icon button 546 for closing the window of advertisement notification 540. User 300 can choose to ignore or dismiss advertisement notification 540 by tapping or clicking icon button 546. Alternatively, user 300 can choose to leave the property of retailer 510 and patronize retailer 544 and present the coupon code to retailer 544 to receive a discount on one of the products sold by retailer 544.

By displaying advertisement notification 540 in the context of triggering event E3, advertisement notification 540 is targeted to a consumer that is more likely to be interested in purchasing a particular product at the moment the advertisement is displayed. Specifically, advertising module 448 of map and navigation application 312 displays advertisement notification 540, which promotes a product of competitor retailer 544, to user 300 in the context of user 300 passing nearby retailer 510. Thus, user 300 is more likely to be inclined to patronize retailer 544 than if user 300 were not close-by or near retailer 510. The purchasing decisions of user 300 are therefore influenced or controlled by delivering an advertisement that is relevant to user 300 and is triggered in the context of the environment or status of mobile device 190 or user 300.

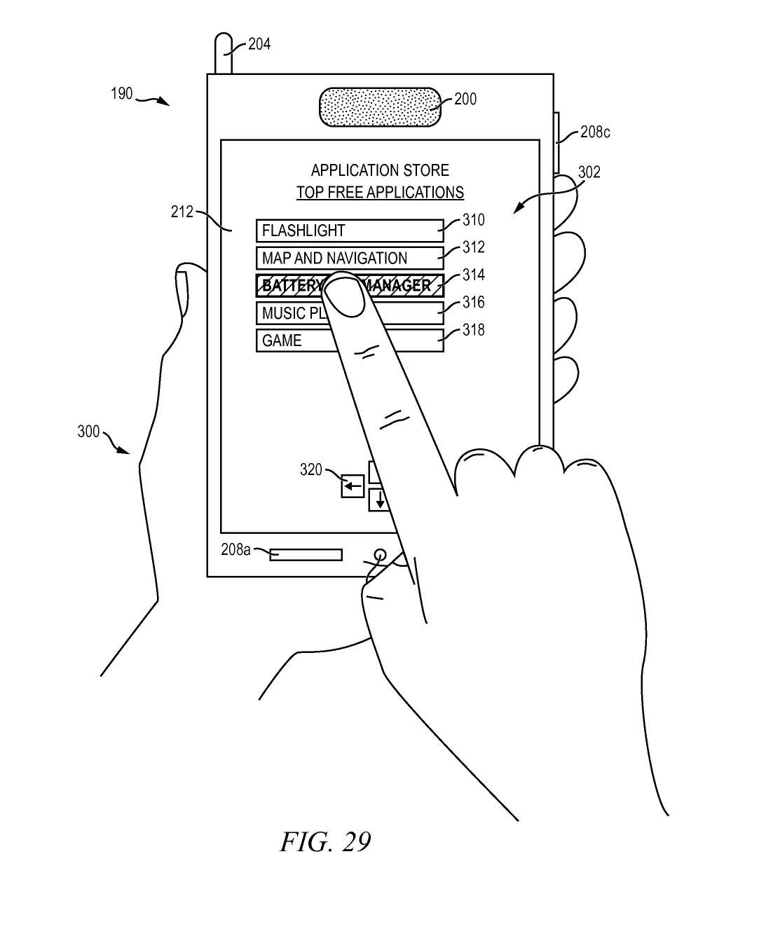

After installing map and navigation application 312 onto mobile device 190 and downloading updates to incorporate advertisements 400 and 410 into advertising module 448, user 300 is concerned about the amount of battery power being consumed from all of the applications running on mobile device 190. User 300 returns to application store graphical interface 302 using mobile device 190 to browse the free software applications for a software application to manage battery power consumption, as shown in FIG. 29. User 300 selects battery life manager 314, and battery life manager 314 is downloaded onto mass storage device 226 or electronic memory 228 of mobile device 190 through data network 20.

Battery life manager 314 is a computer program product, comprising computer readable program code embodied in or recorded on a tangible or non-transitory computer readable or computer usable medium. The computer readable program code of battery life manager 314 is adapted to implement a series of instructions or a method for controlling the hardware and software components of a computer system or mobile device to monitor and manage the battery power consumption of the mobile device. The computer readable program code of battery life manager 314 is also adapted to implement a method of controlling a commerce system through an electronic communication network.

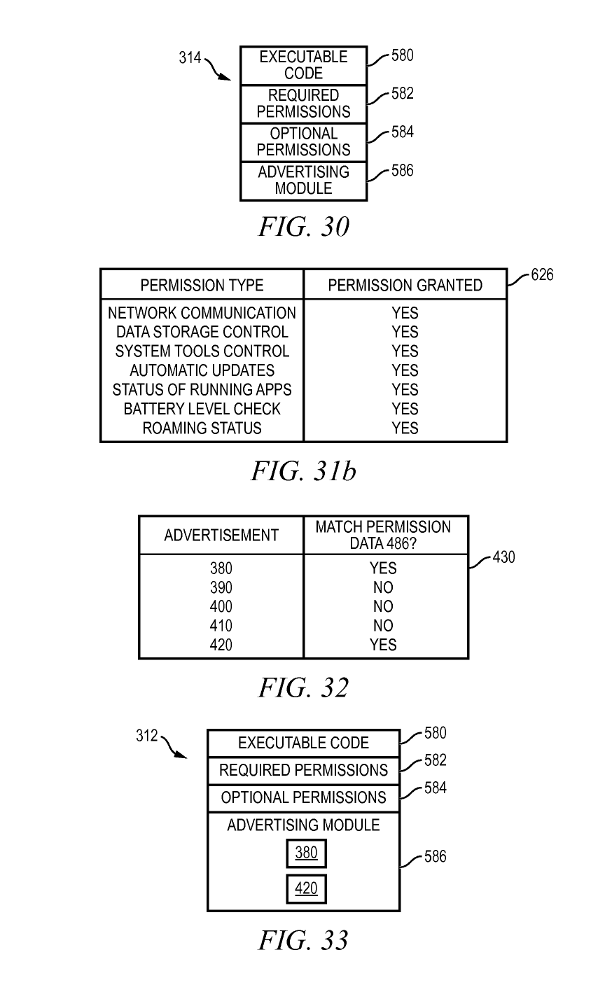

The computer readable program code of battery life manager 314 is embodied in one or more data files and is transferred from advertisement database 144 through data network 20 to mobile device 190 of user 300. Alternatively, user 300 can transfer battery life manager 314 onto mobile device 190 from another computer system in a hard-wired or wireless configuration, or from external computer-readable media. As shown in FIG. 30, battery life manager 314 includes executable code 580, which represents a computer program product containing computer readable program code embodied in a computer program product. Executable code 580 operates as logical functions or a series of executable instructions for performing the functions of battery life manager 314, such as monitoring the power level of a mobile device battery, terminating or stopping applications that are non-essential, or turning off hardware components that consume power but are not being utilized. Executable code 580 can be modified or updated to change the functionality of battery life manager 314. Executable code 580 can also be modified or updated to change the advertisement actions performed by battery life manager 314 and the circumstances under which the advertisement actions are performed.

Battery life manager 314 also includes a list or set of required execution privileges or required permissions 582. Required permissions 582 define the scope of the components, functions, and features of mobile device 190, which battery life manager 314 must be permitted to control or interact with in order for battery life manager 314 to function. Battery life manager 314 further includes a list or set of optional execution privileges or optional permissions 584. Optional permissions 584 define the scope of the components, functions, and features of mobile device 190, which battery life manager 314 does not necessarily need to be permitted to control or interact with for the basic functions of battery life manager 314 to operate. Optional permissions 584 can be optionally included by the software developer of battery life manager 314 in order to provide additional features or functions for battery life manager 314.

Battery life manager 314 also includes advertising module 586. Advertising module 586 is a computer program product containing computer readable program code embodied in a non-transitory computer readable or computer usable medium and serves as the logical engine for monitoring the components and status of a mobile device as well as user behavior according to the scope of the permissions defined by the user. Advertising module 586 is also the logical engine for executing other computer readable program code from advertisements embedded within or associated with battery life manager 314. The computer readable program code from such embedded advertisements is configured or adapted to implement a series of instructions or a method for performing an advertisement action, such as displaying advertisement notifications, promotional text, determining whether and when to display an advertisement, determining compatible advertisements, executing logical functions, running a trial version of a software application, or generally executing a series of instructions intended to promote a product or service. Advertising module 586 can be modified or updated to change the advertisement actions performed by advertising module 586 and the circumstances under which the advertisement actions are performed.

The various pieces or components of battery life manager 314, including executable code 580, required permissions 582, optional permissions 584, and advertising module 586 can be incorporated into one or more data files for battery life manager 314. Battery life manager 314 is stored on mass storage device 226 or electronic memory 228 of mobile device 190. In another embodiment, portions of battery life manager 314 are stored externally on a computer system in electronic communication with mobile device 190 through data network 20.

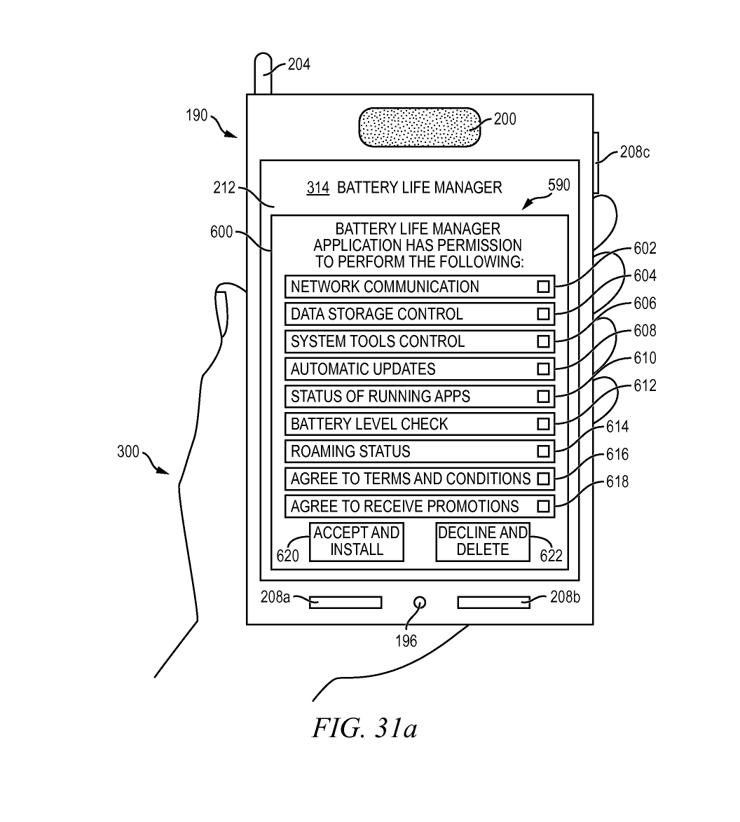

FIG. 31a shows installation screen graphical interface 590 of battery life manager 314 displayed on touchscreen 212 of mobile device 190. A list of approved permissions 600 is requested on installation screen graphical interface 590 to request user 300 select and approve individual permissions and privileges for battery life manager 314 to monitor and control the components and status of mobile device 190. For example, user 300 is asked with individual permission request 602 to give permission for battery life manager 314 to engage in network communication with data network 20. User 300 is asked with individual permission request 604 to give permission for battery life manager 314 to perform data storage control (i.e., read and write data to mass storage device 226 or electronic memory 228). User 300 is asked with individual permission request 606 for permission for battery life manager 314 to perform system tools control (i.e., prevent mobile device 190 from turning off while battery life manager 314 is running). User 300 is asked with individual permission request 608 for permission for battery life manager 314 to perform automatic software updates. User 300 is asked with individual permission request 610 for permission for battery life manager 314 to check and monitor the status of software applications running on mobile device 190. User 300 is asked with individual permission request 612 for permission for battery life manager 314 to perform a battery level check. User 300 is asked with individual permission request 614 for permission for battery life manager 314 to monitor whether mobile device 190 is roaming outside the service provider's data or communication network.

The developer of battery life manager 314 can choose to make some or all of the permissions settings optional, depending on whether the permissions are necessary for battery life manager 314 to function. User 300 is also asked to agree to the terms and conditions of using battery life manager 314 in block 616. User 300 is also asked to agree to receive promotions in block 618. Promotions include offers, deals, or advertisements for products or services. If user 300 indicates agreement to each of the required permission settings, the terms and conditions, and to receive promotional notifications, user 300 can accept the permissions and continue installing battery life manager 314 by touching icon 620. Alternatively, the user 300 can decline to accept the permission requests and optionally delete battery life manager 314 from mobile device 190 by touching icon 622. In another embodiment, the permission settings are accepted or declined by user 300 prior to downloading or delivering battery life manager 314 onto mobile device 190.

If user 300 accepts some or all of the permission requests of battery life manager 314, the responses to the permission requests are saved in mass storage device 226 or electronic memory 228 of mobile device 190. In one embodiment, the responses to the permission requests are saved in mass storage device 226 or electronic memory 228 as permission data 626, as shown in FIG. 22b. In another embodiment, permission data 626 is uploaded to a computer system managed and maintained by application provider 130 or the developer of battery life manager 314 through data network 20. The permission data 626 indicates each type of permission request made by the software application, and the corresponding response of the user. Permission data 626 indicates user 300 was asked to give permission for flashlight application 310 to engage in network communication, perform data storage control, perform system tools control, perform automatic updates, check the status of running software applications, perform a battery level check, and monitor the roaming status of mobile device 190. Permission data 626 also indicates user 300 gave permission for each of the permission requests.

After establishing the relevant permissions to create permission data 626, cross-referencing computer system 430 compares permission data 486 with advertisements 380, 390, 400, 410, and 420 stored in advertisement database 144 to determine whether any of the permissions lists 382, 392, 402, 412, or 422 are consistent with permission data 626, as shown in FIG. 32. Cross-referencing computer system 430 acknowledges that user 300 has agreed to allow battery life manager 314 to engage in network communication (matching permissions P1, P3, P5, P7, and P9), perform a battery level check (matching permissions P2 and P11), and monitor the status of running software applications (matching permission P10). On the other hand, user 300 has not agreed to allow battery life manager 314 to monitor the status of installed software applications (matching permission P4), to allow battery life manager 314 to monitor the status of software installations (matching permission P4), to allow battery life manager 314 to monitor the status of the GPS receiver (matching permission P6), or to monitor the status of the accelerometer (matching permission P8).

Accordingly, cross-referencing computer system 430 determines that advertisements 380 and 420 match, or are compatible with the permissions defined by permission data 626 associated with battery life manager 314. By contrast, cross-referencing computer system 430 determines that advertisements 390, 400, and 410 do not match, or are not compatible with the permissions defined in permission data 626 associated with battery life manager 314.

Because advertisements 380 and 420 are compatible with or match permission data 626 associated with battery life manager 314, advertisements 380 and 420 are downloaded or delivered to mobile device 190 through data network 20 and incorporated into advertising module 586. FIG. 33 shows battery life manager 314 after incorporating advertisements 380 and 420 into advertising module 586. By contrast, because advertisements 390, 400, and 410 are not compatible with permission data 626, advertisements 390, 400, and 410 are not downloaded to mobile device 190 and are not incorporated into advertising module 586.

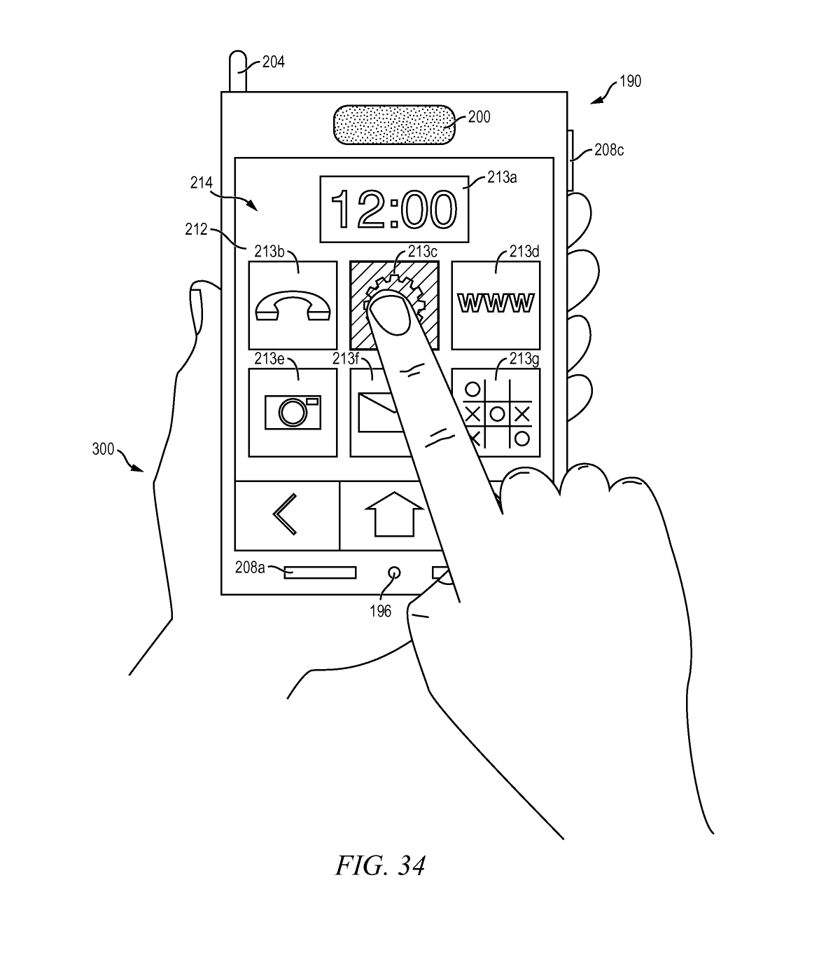

After battery life manager 314 is installed on mobile device 190, and battery life manager 314 has established permission settings or created permission data 626, user 300 notices that the software applications on mobile device 190 are running slowly, and user 300 suspects that too many software applications are running simultaneously and are consuming system resources. User 300 returns to graphical interface home screen 214 and selects settings icon 213c, as shown in FIG. 34, to manage the software applications running on mobile device 190.

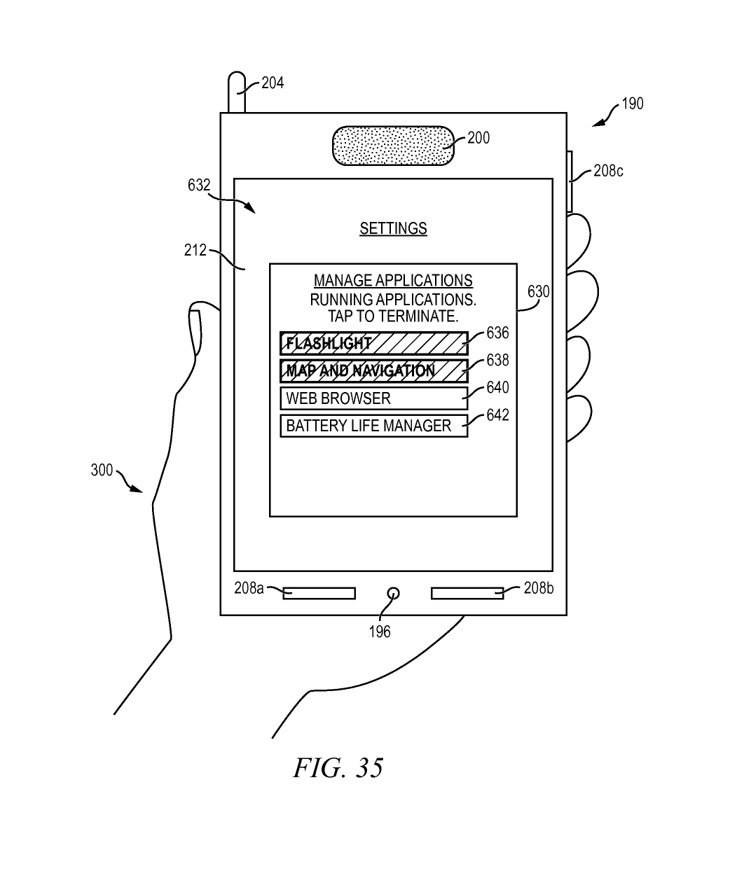

In FIG. 35, user 300 reviews the software applications running on mobile device in the manage applications menu graphical interface 630 on settings screen graphical interface 632. Manage applications menu graphical interface 630 lists the software applications running on mobile device 190, and indicates that user 300 can terminate the software applications by tapping the corresponding icon. Specifically, user 300 can terminate flashlight application 310 by tapping icon 636. User 300 can terminate map and navigation application 312 by tapping icon 638. User 300 can terminate a web browser application by tapping icon 640. User 300 can terminate battery life manager 314 by tapping icon 642. User 300 decides to terminate flashlight application 310 and map and navigation application 312, by selecting icons 636 and 638.

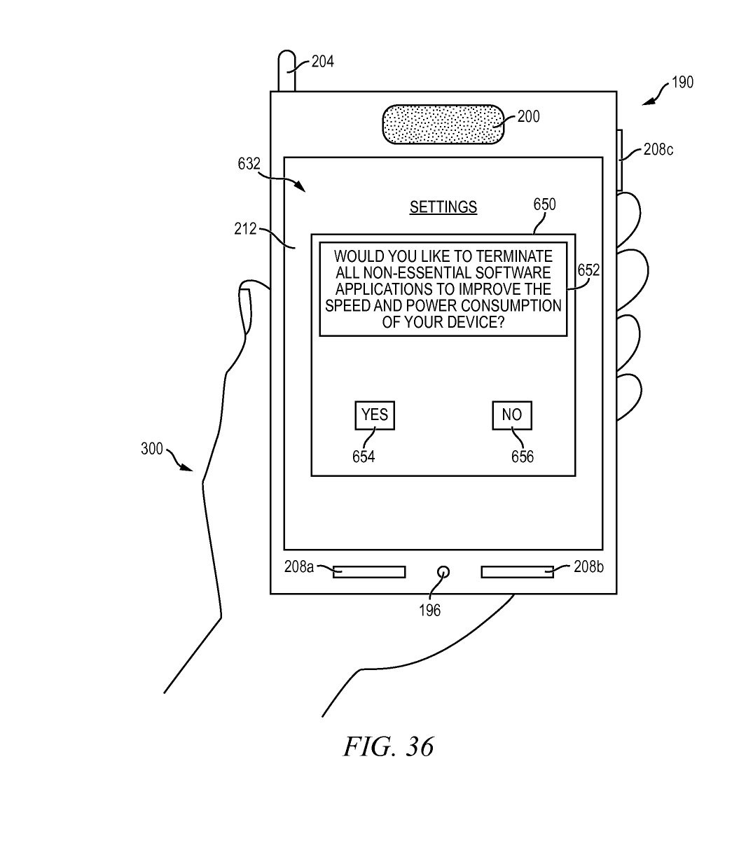

Meanwhile, advertising module 586 of battery life manager 314 monitors the status of mobile device 190 to detect a triggering event. After user 300 begins terminating multiple software applications, i.e., flashlight application 310 and map and navigation application 312, advertising module 586 of battery life manager 314 recognizes that triggering event E5 of advertisement 420 has occurred. In response to triggering event E5, advertising module 586 initiates software code C5 of advertisement 420 to perform action A5 to display overlay promotion or heads-up advertisement notification 650 as an overlay window or notification message layered over settings screen graphical interface 632 and manage applications menu graphical interface 630, as shown in FIG. 36. Thus, advertising module 586 of battery life manager 314 initiates displaying overlay notification 650 to user 300 while user 300 is not actively engaged with using battery manager 300, and instead is engaged with the settings utility through settings screen graphical interface 632, and is terminating software applications using manage applications menu graphical interface 630. Overlay notification 650 can be displayed as a layer on top of the graphical interface of any application or display shown on touchscreen 212. Accordingly, advertising module 586 is capable of delivering overlay notification 650 to user 300 regardless of the activity that user 300 is performing with mobile device, by layering overlay notification 650 over the graphical interface of mobile device 190.

Overlay notification 650 has promotional text 652 asking user 300 whether user 300 would like to terminate all non-essential software applications to improve the speed and power consumption of mobile device 190. Overlay notification 650 also includes an icon button 654, which user 300 can tap to initiate terminating all non-essential software applications. Alternatively, user 300 can choose to ignore or dismiss overlay notification 650 by tapping or clicking icon button 656.

If user 300 chooses to initiate terminating all non-essential software applications by tapping icon button 654, advertising module 586 of battery life manager 314 can initiate terminating all non-essential software applications by continuing to run software code C5. Because software code C5 is embedded in battery life manager 314 through advertisement 420 and contains the software code necessary to execute terminating all non-essential software applications, additional software code need not be installed on mobile device 190. After terminating all non-essential software applications, software code C5 may display additional promotional text to user 300, offering advertisements for additional products or services to further improve the operating speed or power consumption of mobile device 190.

Accordingly, advertisement 420, which is embedded in battery life manager 314, operates as an intelligent or smart advertisement. Advertising module 586 of battery life manager 314 is capable of sensing or monitoring the state, status, and environment of mobile device 190, i.e., whether user 300 has recently terminated multiple software applications. In response to a triggering event E5 (i.e., user 300 terminating multiple software applications), advertising module 586 can initiate smart advertisement 420 to perform an advertisement action (i.e., display promotional text 652). Advertising module 586 is further capable of executing software code C5 of smart advertisement 420, which is a computer program product containing computer readable program code embodied in a non-transitory computer readable or computer usable medium, to perform a logical function (i.e., terminating all non-essential software applications running on mobile device 190). Smart advertisement 420 is embedded within battery life manager 314, and is compatible with the execution privileges of battery life manager 314. In other words, smart advertisement 420 does not require any execution privileges beyond the execution privileges user 300 has already agreed to in order to run battery life manager 314. Thus, user 300 has agreed to all of the execution privileges necessary for advertising module 586 of battery life manager 314 to monitor the status of mobile device 190 to detect triggering event E5 and to execute software code C5 of smart advertisement 420 to perform a logical function (i.e., terminate all non-essential software applications). Smart advertisement 420 has additional functionality, such as displaying additional promotional text to user 300 with a hyperlink to a product sales page for additional products or services to improve the operating speed or power consumption of mobile device 190.

Accordingly, advertising module 586 of battery life manager 314 controls the commerce system by influencing the purchasing decisions of user 300 by presenting user 300 with a promotional advertisement notification in the context of the environment or status of mobile device 190. By displaying overlay notification 650 in the context of triggering event E5, overlay notification 650 is targeted to a consumer that is more likely be interested in purchasing a particular product at the moment the advertisement is displayed. Specifically, advertising module 586 of battery life manager 314 displays overlay notification 650, which promotes a software application that improves the operating speed and power consumption of a mobile device, with some functionality of the software application embedded within battery life manager 314. Overlay notification 650 is displayed in the context of user 300 terminating multiple software applications in an effort to improve the operating speed of mobile device 190. Thus, user 300 is more likely to be inclined to run the free trial version of the software application offered by overlay notification 650 and later purchase a full version of the software application than if user 300 had not recently been attempting to improve the operating speed of mobile device 190. The purchasing decisions of user 300 are therefore influenced or controlled by delivering an advertisement that is relevant to user 300 and is triggered by the context of the environment or status of mobile device 190.

Additionally, advertising module 586 of battery life manager 314 is capable of displaying promotional text 652 of overlay notification 650 while user 300 is engaging with a separate software application, or at any time that a triggering event occurs, regardless of whether user 300 is actively engaging with battery life manager 314. Specifically, overlay notification 650 is displayed by advertising module 586 of battery life manager 314 while user 300 is engaging with settings screen graphical interface 632. Overlay notification 650 is displayed as a window overlaying the graphical interface of settings screen graphical interface 632. Accordingly, advertising module 586 displays overlay notification 650 even though user 300 is not actively engaging with battery life manager 314. By displaying overlay notification 650 in response to triggering event E5, at the moment that triggering event E5 occurs, the promotional text 652 of overlay notification 650 is more likely to be relevant to the purchasing decisions of user 300.

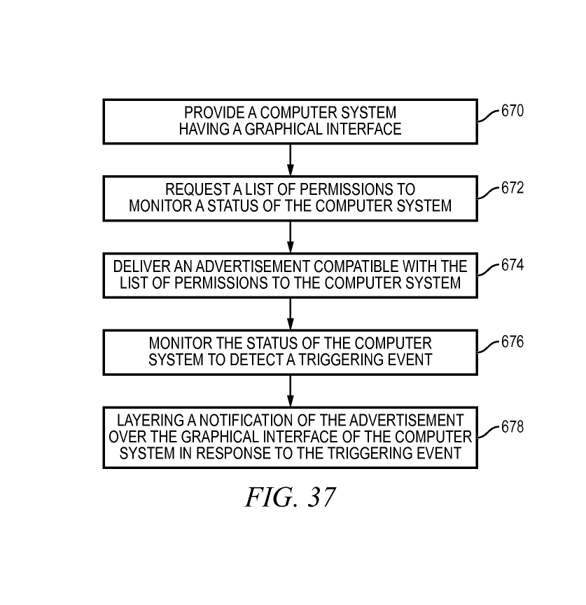

FIG. 37 illustrates a process for controlling a commerce system by displaying compatible advertisements on a computer system in response to triggering event. In step 670, a computer system having a graphical interface is provided. In step 672, a list of permissions to monitor a status of the computer system is requested. In step 674, an advertisement compatible with the list of permissions is delivered to the computer system. In step 676, the status of the computer system is monitored to detect a triggering event. In step 678, a notification of the advertisement is layered over the graphical interface of the computer system in response to the triggering event.

In summary, the application provider in part controls the movement of goods between members of the commerce system. The application provider manages and maintains an application database of software applications for use with a computer system. The database is in electronic communication with a data network. A consumer has a computer system such as a mobile device or smartphone, which is also in electronic communication with the data network. The consumer can browse among the various choices of software applications in the application database, and choose to download a software application to the mobile device. After delivering the software application to the mobile device, during the installation process, the user responds to a variety of required requests for permission to monitor the status of the components of the mobile device, which are necessary for the software application to function on the mobile device. The user may also be asked to respond to a variety of optional requests for permission to monitor the status of components of the mobile device, which are not necessary for the software application to function, but which may improve the functionality of the software application. The user's responses to the permission requests are compiled into a list of approved permissions.

Meanwhile, advertisements provided by an advertiser or advertiser network are stored in an advertisement database. A list of required permissions required for displaying the advertisement on a mobile device is associated with each advertisement. Additionally, associated with each advertisement is a triggering event, and an associated advertising action to occur at the occurrence of the triggering event. For example, the action could include displaying promotional text for products or services the advertiser wishes to promote. The consumer can choose to select hyperlinked text to be redirected to a product sales Internet website, where the user can further research the product or service or choose to purchase the product or service. The advertisement also includes segments of executable software code or computer readable program code embodied in a non-transitory computer usable medium, which can execute a set of instructions to control the computer system or perform a logical function.

A cross-referencing computer system compares the list of required permissions of the advertisements with the list of approved permissions to determine whether any of the advertisements are compatible with the permissions indicated by the consumer. If the cross-referencing computer system determines that one or more advertisements are compatible with the permissions indicated by the consumer, the compatible advertisements are downloaded to the consumer's computer system. In one embodiment, portions of the advertisements are not immediately downloaded to the computer system, but rather are downloaded dynamically through the data network if a triggering event occurs. Meanwhile, the software application monitors the status of the consumer's mobile device, consistent with the permissions indicated by the consumer, to determine if a triggering event occurs. If the software application detects the occurrence of a triggering event, the software application initiates execution of the executable software code to perform the action associated with the advertisement. The action associated with the advertisement includes layering a notification of the advertisement over the graphical interface of the computer system.

By layering the advertisement notification over the graphical interface of the computer system or performing the action associated with the advertisement in the context of a triggering event, the advertiser and the application provider influence the flow of goods in the commerce system. A consumer is more likely to be interested in the particular advertised product or service because the consumer is exposed to the advertisement in the context of the status of the consumer's mobile device or computer system. Thus, advertisements can be targeted to particular consumers under extremely specific circumstances, such that the consumers are exposed to more relevant advertisements. Similarly, advertisers and application developers are able to provide fewer advertisements by increasing the likelihood that a particular advertisement is displayed to a consumer who will convert into a purchaser of the product or service.

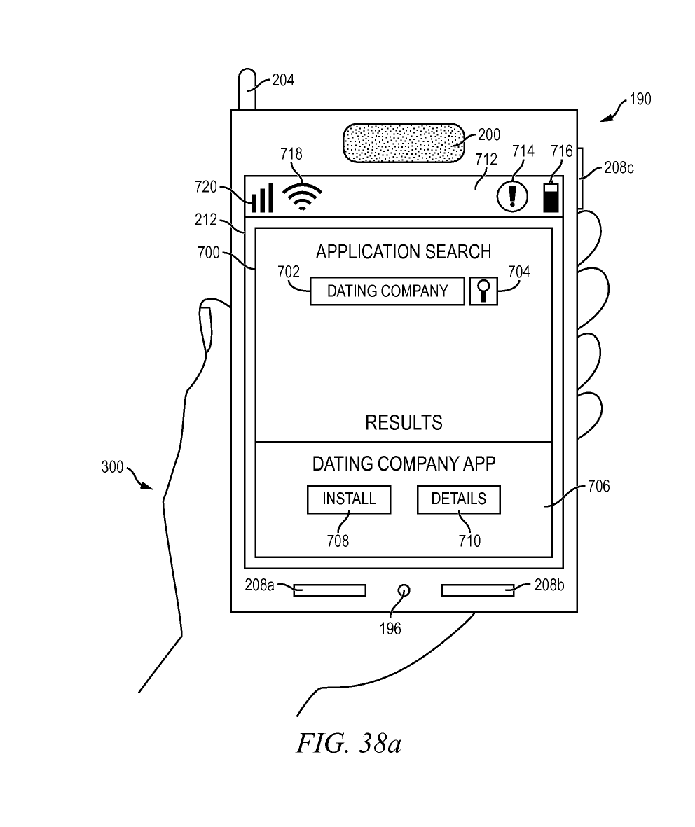

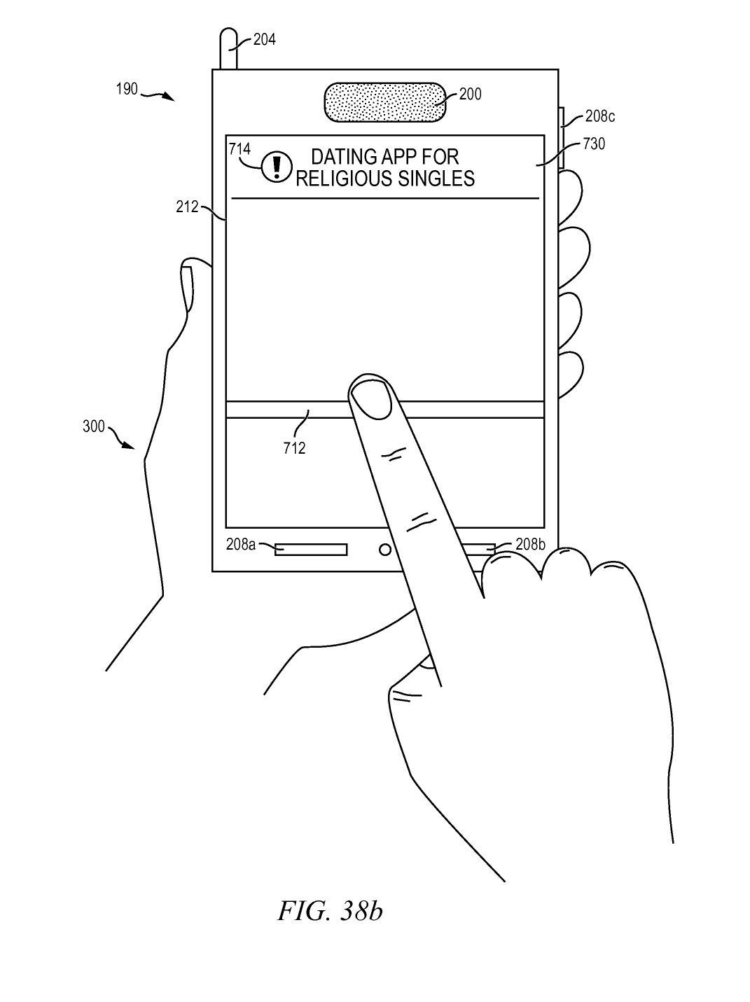

FIG. 38a illustrates user 300 at an application search screen 700 displayed on touchscreen 212 of device 190. Application search screen 700 includes a search field 702 and a search button 704. User 300 enters search terms into search field 702 and presses button 704 to submit the search. For example, user 300 is single and searching for a new dating application. User 300 enters the name Dating Company into search field 702 and presses button 704. The application search for Dating Company successfully locates the Dating Company application displayed in results block 706. Results block 706 also includes install button 708 and details button 710. Notification bar 712 contains system status information and displays incoming notifications. Notification bar 712 includes promotion notification 714, battery status 716, wireless internet status 718, and cellular status 720.

An advertising module is installed on the computing device to monitor for triggers and present advertisements such as promotion notification 714. For example, FIG. 11 illustrates advertising module 328 installed with flashlight application 310. Advertising module can be installed individually as a standalone application, bundled with a third party application, or as a part of a third party application. An advertising module like advertising module 328 is installed as a part of any application by being made available to developers of the applications as part of a software development kit. Once installed, the advertising module enables real-time access to information regarding activities of user 300 such as app searches, app downloads, app installations, location, or any other potential triggers for advertisements. When a trigger is detected, advertising module 328 can execute code, perform an action, or present a promotion or message. The advertising module can present advertisements using audio, overlay, notification, or other visual techniques.

Promotion notification 714 is triggered by user activity, phone contents, app installation, app downloads, apps present on the device, location, or other events that can be monitored to trigger promotions. Triggers can also be based on other user activity. For example, web searches, browsing history, application search terms, or file downloads. Once a trigger is detected by advertising module 328, an advertisement or other activity is carried out. For example, advertiser 140 can present an overlay promotion, notification promotion, email promotion, text message promotion, audio promotion or any other promotion deliverable to user 300 by a computing device. One type of promotion that advertising module 328 presents is a notification.

In FIG. 38a, promotion notification 714 is presented at the top of screen 212. Promotion notification 714 indicates to user 300 that an advertisement is available for review. Promotion notification 714 contains content displayed by advertising module 328 after a corresponding trigger is detected. In FIG. 38b, user 300 expands promotion notification 714 by sliding the notification bar downward. Promotion notification 714 indicates that Dating App for Religious Singles is available to user 300 and may be of interest. User 300 installs Dating App for Religious Singles by selecting notification 714 and using an installation interface.

Different promotion notifications can be triggered by different events or conditions. In one embodiment, a promotion notification is preselected for presentation whenever advertising module 328 detects an application download, installation, or launch of a specific application. Usually, the specific application used as a trigger relates to the promotion so that user 300 is more likely to make a positive decision because of the promotion. A retailer pays to advertise a product or service when advertising module 328 detects a specific triggering event, such as a download, installation, search, or launch of an application. Competing application developers can pay to promote their product when a rival application is installed, downloaded, launched, or running. For example, a first dating company competes with a second dating company to provide online dating services through a mobile application. The second dating company purchases the right to present a notification for its product to consumers when a user downloads an application by the first dating company. User 300 downloads a dating application from the first company. Advertising module 328 detects the download as a triggering event and presents a notification or overlay promotion for an application by the competing second dating company. Alternatively, advertising module 328 can place banner advertisements or interstitial advertisements in running applications when the trigger for the banner or interstitial is one or more applications running on device 190. Returning to FIG. 38b, if user 300 finds the promotion notification persuasive then the user downloads or further researches the application by the second dating company.

By presenting the promotion on the graphical interface of the computer system or performing the action associated with the advertisement in the context of a triggering event, the advertiser and the application provider influence the flow of goods in the commerce system. A consumer is more likely to be interested in the particular advertised product or service because the consumer is exposed to the advertisement in the context of the status of the consumer's mobile device or computer system. Thus, advertisements can be targeted to particular consumers under specific circumstances, such that the consumers are exposed to more advertisements that are relevant. Similarly, advertisers and application developers are able to provide fewer advertisements by increasing the likelihood that a particular advertisement is displayed to a consumer who will convert into a purchaser of the product or service.

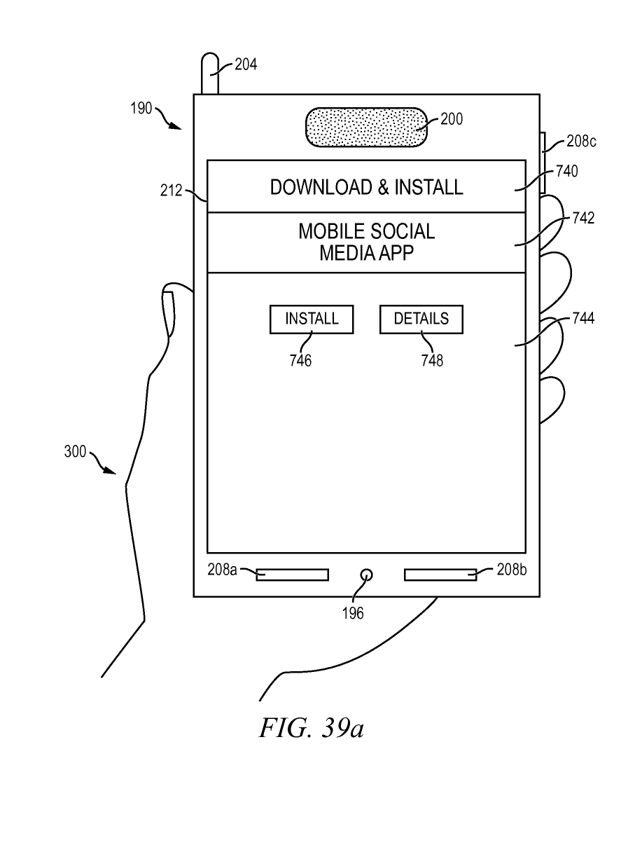

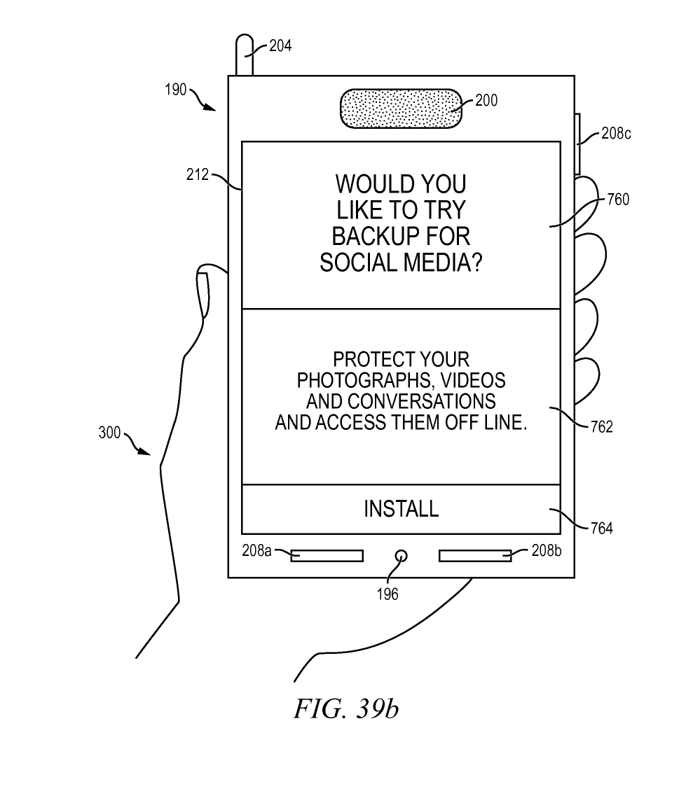

In FIG. 39a, user 300 accesses application installation interface 740 to install a social media application 742 using control block 744 including an install button 746 and details button 748. User 300 presses install button 746 to install social media application 742. A backup company offering a social media backup application finds that users who install social media application 742 frequently want or need the Backup for Social Media application. The backup company submits a promotion for its application, Backup for Social Media, to application provider 130, advertiser 140, or advertisement database 146 to be presented any time a user installs social media application 742. Advertising module 328 monitors activity on mobile device or computer system 190. When user 300 installs social media application 742, advertising module 328 detects the installation and triggers the presentation of overlay promotion 760 advertising the Backup for Social Media application.

In FIG. 39b, overlay promotion 760 queries whether user 300 would like to try Backup for Social Media. Installation acts as a trigger for other promotion mediums as well, i.e., a notification promotion, an email promotion, a text message promotion, an audio promotion, a banner promotion, an interstitial promotion, or any other promotion deliverable to user 300 by a computing device. Custom promotional text or images appear in block 762, informing user 300 that Backup for Social Media protects photographs, videos, and conversations while enabling offline review of content. User 300 can install the Backup for Social Media application by pressing install button 764. The overlay promotion can also redirect user 300 to a web site to further research the promoted applications, goods, or services or to an application store to install the application.

By layering the advertisement notification over the graphical interface of the computer system or performing the action associated with the advertisement in the context of a triggering event, the advertiser and the application provider influence the flow of goods in the commerce system. A consumer is more likely to be interested in the particular advertised product or service because the consumer is exposed to the advertisement in the context of the status of the consumer's mobile device or computer system. Thus, advertisements can be targeted to particular consumers under extremely specific circumstances, such that the consumers are exposed to more relevant advertisements. Similarly, advertisers and application developers are able to provide fewer advertisements by increasing the likelihood that a particular advertisement is displayed to a consumer who will convert into a purchaser of the product or service.

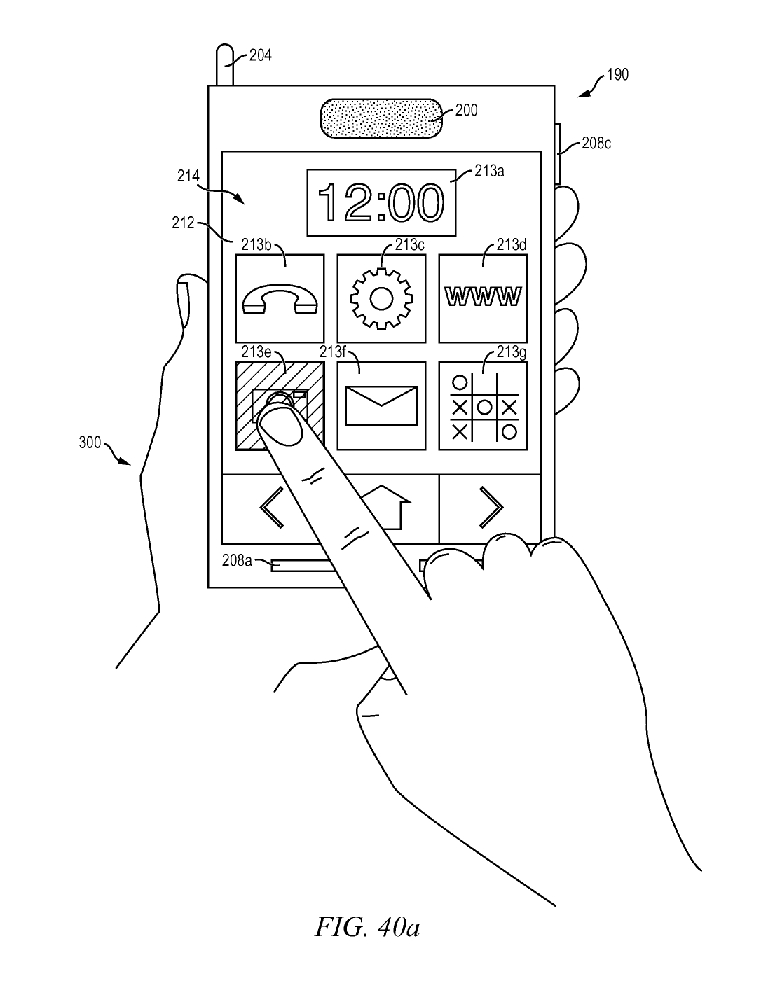

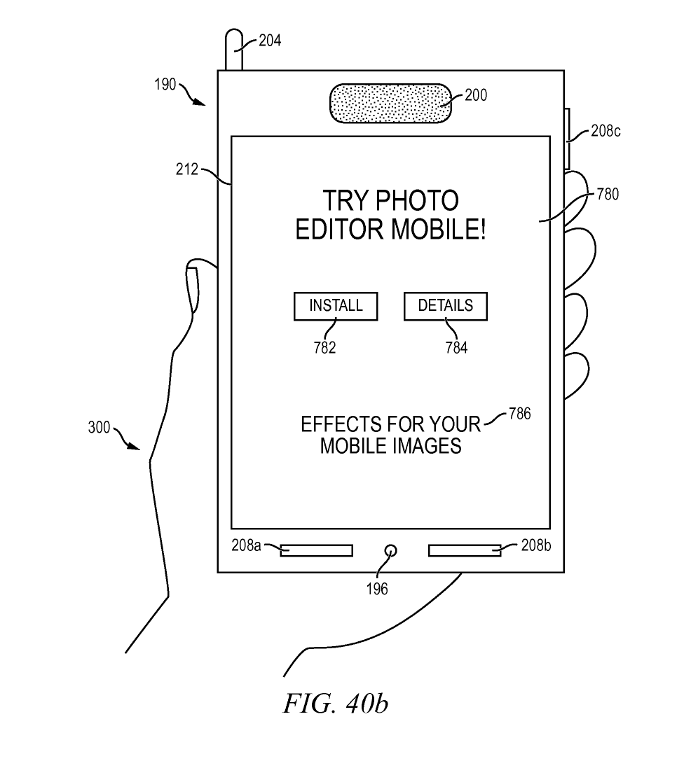

FIG. 40 illustrates user 300 at the home screen of device 190. Mobile device 190 displays icons and digital buttons on touchscreen 212 in the form of a plurality of icons 213a-213j, which enables a user to selectively interact and engage with mobile device 190. For example, mobile device 190 has a digital clock software application installed on the device and user 300 can read the time displayed within icon 213a on touchscreen 212, or change the time, set an alarm, or start a timer by tapping clock icon 213a to bring up a separate screen or digital display on touchscreen 212. A user can make a telephone call by touching phone icon 213b to bring up a telephone graphical interface screen 215, as shown in FIG. 6b. Returning to FIG. 40a, a user can choose to review and change settings of mobile device 190 by touching settings icon 213c, or browse the Internet by touching browser icon 213d. A user can choose to capture or review photos by touching camera icon 213e. A user can send or receive voice, email, or Short Message Service (SMS) text messages by touching message icon 213f. A user can browse, play, or purchase games by touching game icon 213g. Several other software applications or functionalities are installed on mobile device 190 and a user can navigate through the various choices by touching navigation icons 213h or 213i. A user can also return to a home screen by touching home icon 213j. Graphical interface home screen 214 displays each of the icons 213a-213j, for interacting with the operating system and software applications of mobile device 190. Any activity by user 300 can be monitored by advertising module 328 and serve as a triggering event.

User 300 selects camera icon 213e to launch a camera application for taking photographs using mobile device 190. Advertising module 328 is installed on mobile device 190 and monitors mobile device 190 to detect when a camera application is launched. The launch of a camera application is detected by advertising module 328 and triggers a promotion, i.e., a notification promotion, an email promotion, a text message promotion, an audio promotion, a redirection to a web site or application store, a banner promotion, an interstitial promotion, or any other promotion deliverable to user 300 by a computing device. In FIG. 40b, advertising module 328 presents an overlay promotion 780 on screen 212 of mobile device 190.

Overlay promotion 780 includes installation button 782. When user 300 presses installation button 782 an application embedded in overlay promotion 780 is installed. Alternatively, pressing installation button 780 can result in a redirection to an application store, web site, or direct download to download and install the application. User 300 presses details button 784 to further research the service or application in overlay promotion 780. After pressing details button 784, user 300 is redirected to an application store or web site containing further information regarding the application or service from overlay promotion 780. Overlay promotion 780 includes text, images, audio, or other messages to entice user to download or purchase the applications, goods, or services promoted in overlay promotion 780. User 300 can choose to install or research the applications, goods, or services being promoted as desired, i.e., the Photo Editor Mobile application in FIG. 40b. User 300 can also ignore the overlay promotion and continue to use the application that triggered overlay promotion 780.

By layering overlay promotion 780 over the graphical interface of the computer system or performing the action associated with the advertisement in the context of a triggering event, the advertiser and the application provider influence the flow of goods in the commerce system. A consumer is more likely to be interested in the particular advertised product or service because the consumer is exposed to the advertisement in the context of the status of the consumer's mobile device or computer system. Thus, advertisements can be targeted to particular consumers under extremely specific circumstances, such that the consumers are exposed to more relevant advertisements. Similarly, advertisers and application developers are able to provide fewer advertisements by increasing the likelihood that a particular advertisement is displayed to a consumer who will convert into a purchaser of the product or service.

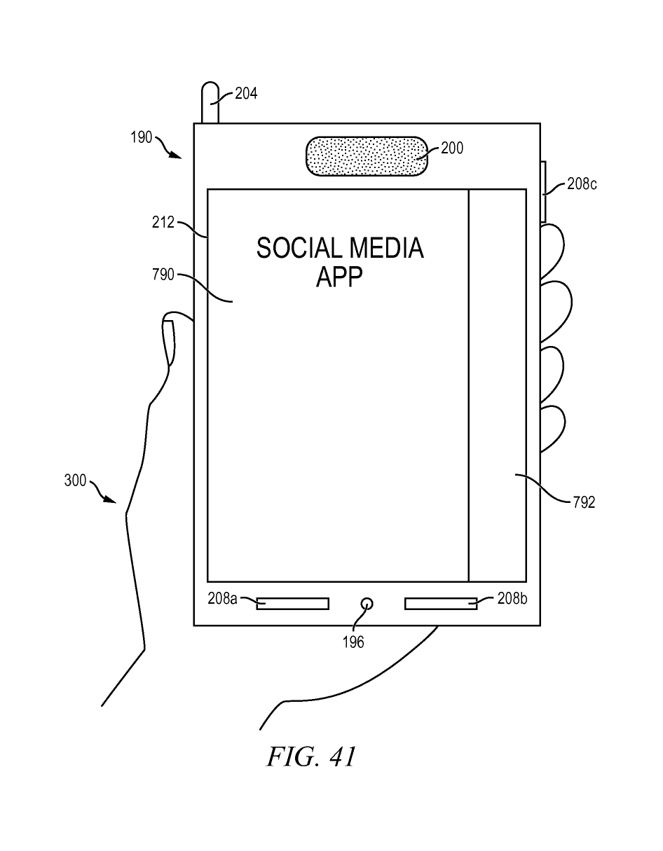

FIG. 41 illustrates a banner advertisement triggered by detecting a set of running applications. In addition to selecting promotions for presentation based on a payment by an advertiser or retailer, promotions can be selected in part or in whole based on applications already installed or running on a device. Retailers and advertisers can bid or pay to have their promotions presented for any particular triggering event. For example, a social media company provides application 790 that user 300 has installed and is currently running on her device. User 300 has also installed application from a book company for reading and storing books on her device. User 300 also installed an application for storing and playing audio files offered by a music company. A banner promotion 792 for an audio book application is submitted and is triggered whenever a book reading application and an audio playback application are installed on mobile device 190 and social media application 790 is running. In other words, the trigger for banner promotion 792 of the audio book application is when device 190 has certain applications installed and running on a user device.

If the advertisement module detects the occurrence of a triggering event, the software application initiates execution of the executable software code to perform the action associated with the triggering event. Continuing the example in FIG. 41, the trigger is a book reading and audio playback application present on a user device while a social media application is running, as shown in social media application 790 on device 190. The advertising module present on the phone of user 300 monitors the installed and running applications on device 190 to detect triggering events. The advertising module detects the book reading application from the book company and the audio playback application from the music company. Additionally, the advertising module detects that social media application 790 is running in the foreground on device 190. After detecting the presence of the trigger applications installed and running, the advertising module presents a notification, overlay, or other promotion for the audio book application to user 300. In FIG. 41, advertising module 328 presents a banner promotion 792 along a side region of social media application 790. Banner promotion 792 can also be presented at a top, bottom, or central position of social media application 790. Alternatively, an interstitial promotion or web site can be presented overlaying social media application 790.

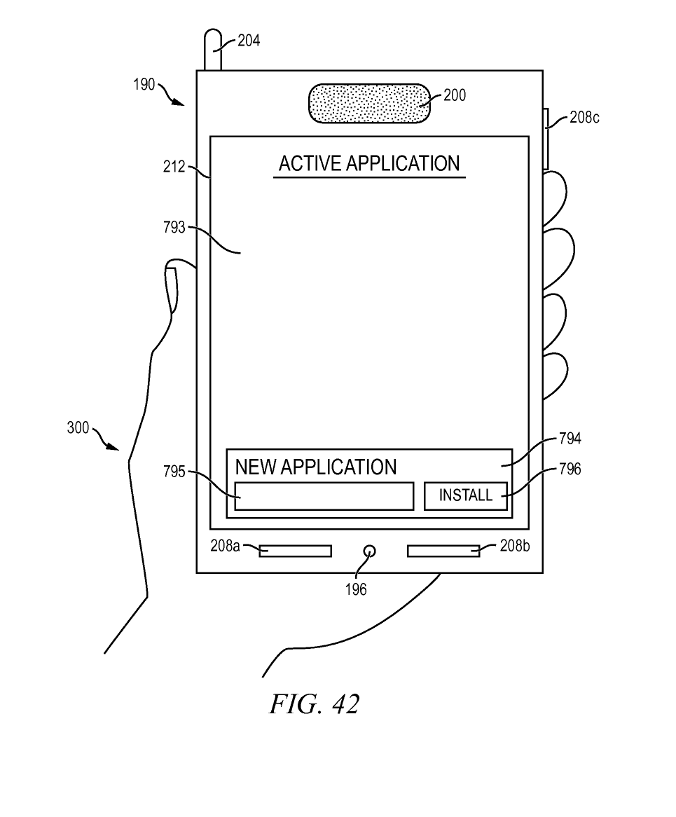

FIG. 42 illustrates a banner advertisement displayed on device 190 in active application 793. Banner advertisement 794 is triggered when an advertising module detects a set of running or installed applications. Device 190 displays active application 793 on touchscreen 212. For example, active application 793 is a recipe application for chicken preparation. Device 190 is also running a social media application and a photograph application, but user 300 is not actively using the social media or photograph application. Advertising module 328 detects that device 190 has the social media application and photograph application running in the background. Advertising module 328 displays banner advertisement 794 within active application 793, the recipe application, with banner advertisement 794 being triggered based on the social media and photograph applications running on device 190. The content of banner advertisement 794 promotes a product that user 300 is likely to want based on the context of the running applications. Banner advertisement 794 includes text or image content in block 795 that is selected to promote a product in the context of the applications that trigger banner advertisement 794. For example, since the trigger for banner advertisement 794 was the social media application and photograph application running on device 190, content block 795 includes text saying, “Like the social media application? Like the photograph application? You'll love our NEW SOCIAL APP!” Banner advertisement 794 also includes block 796 so that user 300 can perform an action in response to banner advertisement 794. User 300 presses the install button in block 796 to install the promoted social app.

In another example, active application 793 is a new application for reading popular news articles and is installed and running on device 190. Device 190 also has a casino application, a poker application, and a sports odds application installed. Advertising module 328 includes a list of applications and triggers banner advertisement 794 within active application 793 whenever two or more applications from the list of applications are installed on device 190. Advertising module 328 detects the casino, poker, and sports odds applications installed on device 190 and presents banner advertisement 794 in response to the triggering event. Banner advertisement appears within active application 793 in use by user 300. The content in block 795 says, “Try our NEW POKER APP?” User 300 presses install button in block 796 to install the promoted poker application. User 300 is more likely to install the promoted poker application than the average user because user 300 has an interest in poker applications based on the installed applications running on his device.

In another example, device 190 is running a travel application for finding flights, hotels, and rental cars. The active application is a game application that is capable of displaying advertisements. The game application includes advertising module 328 to detect triggering events and display advertisements. Advertising module 328 detects that the travel application recently ran on device 190 and displays banner advertisement 794 promoting a discount travel application in response to the triggering event. The content in block 795 includes an image of a tropical destination as well as text indicating the name of the discount travel application. User 300 presses the install button in block 796 to install the discount travel application.

In another example, device 190 is running a web browsing application. Advertising module 328 installed on device 190 scans device 190 to detect applications that were purchased and installed on device 190 rather than downloaded and installed free of charge. Advertising module 328 presents banner advertisement 794 when a certain number of paid applications are installed on device 190, two or more paid applications being the trigger in the present example. User 300 paid for a social media application and a photo editing application and installed both paid applications on device 190. Advertising module 328 detects the two paid applications installed on device 190 and displays banner advertisement 794 on touchscreen 212 in response to the triggering event. Banner advertisement 794 displays a music application with an optional paid music service, available for purchase or download in response to the triggering event. User 300 presses install button in block 796 of banner advertisement 794 to purchase and install the promoted application.

By displaying banner promotion 794 over active application 793 in the context of a triggering event, the advertiser and the application provider influence the flow of goods in the commerce system. A consumer is more likely to be interested in the particular advertised product or service because the consumer is exposed to the advertisement in the context of the status of the consumer's mobile device or computer system. Thus, advertisements can be targeted to particular consumers under extremely specific circumstances, such that the consumers are exposed to advertisements that are more relevant. Similarly, advertisers and application developers are able to provide fewer advertisements by increasing the likelihood that a particular advertisement is displayed to a consumer who will convert into a purchaser of the product or service.

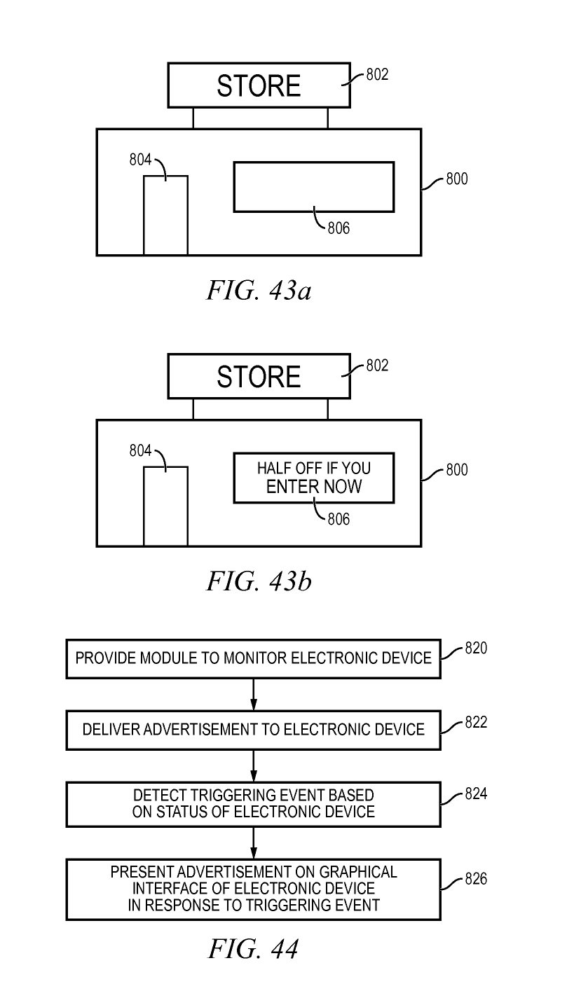

In FIGS. 43a-43b, triggered advertisements are presented using augmented reality devices such as digital glasses, contacts, or implants that present visual or audio information. FIG. 43a shows building 800 as viewed without an augmented reality device. Building 800 includes a sign on the storefront indicating the name or type of establishment housed in building 800. Building 800 includes door 804 and advertisement space 806. Advertisement space 806 can be a window, a wall, an open space, or another part of building 800 that can be covered with an advertisement to user 300 using an augmented reality device. Door 804 can also be used as an advertising space. The location of user 300 is a trigger, as shown in FIG. 27. Additionally, augmented reality device can detect the field of vision of user 300 to determine when advertisement space 806 is present.

In FIG. 43b, the augmented reality device detects that user 300 is present outside building 800. Augmented reality device also detects the direction in which user 300 is looking using a digital compass, level, accelerometer, or image processing. The location and the field of vision of user 300 triggers delivery of augmented reality advertisement in advertising space 806. The augmented reality device presents text and images in advertising space 806. A user without an augmented reality device would perceive advertising space 806 as a blank wall or window, as shown in FIG. 43a. However, user 300 with an augmented reality device is presented with a targeted advertisement in advertisement space 806, “Half off if you enter now,” in FIG. 43b based on location and field of vision. An augmented reality device displays advertisements to user 300 that appear in predetermined locations to target user 300 based on location and field of vision.

By layering presenting an augmented reality promotion in advertisement space 806 in the context of a triggering event, the advertiser and the application provider influence the flow of goods in the commerce system. A consumer is more likely to be interested in the particular advertised product or service because the consumer is exposed to the advertisement in the context of the status of the consumer's augmented reality device. Thus, advertisements can be targeted to particular consumers under extremely specific circumstances, such that the consumers are exposed to more relevant advertisements. Similarly, advertisers and application developers are able to provide fewer advertisements by increasing the likelihood that a particular advertisement is displayed to a consumer who will convert into a purchaser of the product or service.

FIG. 44 illustrates a process for controlling a commerce system by displaying compatible advertisements on a computer system in response to a triggering event. In step 820, a module is provided to monitor an electronic device. In step 822, an advertisement is delivered to the electronic device. In step 824, a triggering event is detected based on a status of the electronic device. In step 826, an advertisement is presented on a graphical interface of the electronic device in response to the triggering event.

In summary, the application provider in part controls the movement of goods between members of the commerce system. The application provider manages and maintains an application database of software applications and advertisements for use with a computer system. The database is in electronic communication with a data network. A consumer has a computer system such as a mobile device, smartphone, or augmented reality device, which is also in electronic communication with the data network. The consumer can browse among the various choices of software applications in the application database, and choose to download a software application to the mobile device. The consumer can also run applications or provide other activities to serve as triggering events. The user is presented with an advertisement in response to a triggering event.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commerce system, comprising:
providing a module to monitor an electronic device;
delivering an advertisement and a triggering event to the module;
detecting the triggering event based on a status of the electronic device; and
presenting the advertisement on a graphical interface of the electronic device in response to the triggering event.

2. The method of claim 1, further including storing the advertisement in a database.

3. The method of claim 1, wherein presenting the advertisement includes presenting a notification.

4. The method of claim 1, wherein presenting the advertisement includes presenting an overlay.

5. The method of claim 1, wherein the advertisement further includes a list of triggering events containing the triggering event.

6. The method of claim 1, wherein the triggering event includes an application download or an application installation.

7. A method of controlling a commerce system, comprising:
delivering an advertisement to an electronic device;
monitoring an electronic device for a triggering event; and
presenting the advertisement on a graphical interface of the electronic device in response to the triggering event.

8. The method of claim 7, further including storing the advertisement in a database.

9. The method of claim 7, further including providing a module to monitor the electronic device for the triggering event.

10. The method of claim 7, wherein presenting the advertisement includes presenting a notification.

11. The method of claim 7, wherein presenting the advertisement includes presenting an overlay.

12. The method of claim 7, wherein the advertisement further includes a list of triggering events containing the triggering event.

13. The method of claim 7, wherein the triggering event includes a search for an application.

14. A method of controlling a commerce system, comprising:
monitoring a status of a computer system to detect a triggering event; and
presenting an advertisement over an interface of the computer system in response to the triggering event.

15. The method of claim 14, further including:
storing the advertisement in a database; and
delivering the advertisement to the computer system.

16. The method of claim 14, wherein the triggering event includes a set of running applications.

17. The method of claim 14, wherein presenting the advertisement includes presenting a notification of the advertisement.

18. The method of claim 14, wherein presenting the advertisement includes presenting an overlay.

19. The method of claim 14, further including presenting choices for selecting individual permissions to monitor a component of the computer system.

20. The method of claim 14, wherein the triggering event includes an application search, an application download, or an application installation.

21. A computer program product usable with a programmable computer processor including a computer readable program code embodied in a non-transitory computer usable medium, the computer readable program code adapted to implement a method for controlling a commerce system, comprising:
delivering an advertisement to an electronic device;
monitoring an electronic device for a triggering event; and
presenting the advertisement on a graphical interface of the electronic device in response to the triggering event.

22. The method of claim 21, further including storing the advertisement in a database.

23. The method of claim 21, further including providing a module to monitor the electronic device for the triggering event.

24. The method of claim 21, wherein presenting the advertisement includes presenting a notification or overlay.

25. The method of claim 21, wherein the triggering event includes a search for an application, an application download, or an application installation.
